(19) United States
(12) Patent Application Publication
(10) Pub. No.: US 2015/0294525 A1
(43) Pub. Date: Oct. 15, 2015

(54) ITEM DISPENSING APPARATUS

(71) Applicant: INNOVATIVE PRODUCT ACHIEVEMENTS, LLC, Suwanee, GA (US)

(72) Inventors: WARD BROOM, SNELLVILLE, GA (US); KYLE JOINER, ROSWELL, GA (US)

(73) Assignee: INNOVATIVE PRODUCT ACHIEVEMENTS, LLC, Suwanee, GA (US)

(21) Appl. No.: 14/249,998

(22) Filed: Apr. 10, 2014

(51) Int. Cl. G07F 11/62; B62B 3/00

(52) U.S. Cl. CPC G07F 11/62; B62B 3/004; B62B 3/003

(57) ABSTRACT

Various embodiments of the present invention are directed to a dispenser configured for securely storing one or more items and dispensing the stored items to authorized users. According to various embodiments, the dispenser generally includes a housing defining an interior area dimensioned to receive one or more items, a laterally sliding access door configured to provide restricted access to items stored within the dispenser, and one or more locking mechanisms designed to inhibit unauthorized access to the interior of the housing. In various embodiments, the dispenser is configured to accept a storage cart, and includes a plurality of guide walls located within the housing and configured to facilitate positioning of the cart within the interior area of the housing.

### BACKGROUND OF THE INVENTION

1. Field of the Invention

Various embodiments of the present invention described herein generally relate to item dispensers, and, in particular, to item dispensers having improved usability characteristics and improved theft prevention features for preventing access to one or more items stored within the dispenser.

2. Description of Related Art

Item dispensers are frequently used to dispense a variety of items, such as food products, toiletries, and other goods to various users. In the healthcare industry, dispensers are often placed in hospitals and used to distribute linens, surgical scrubs, and other healthcare items to members of a hospital's staff. These dispensers can be configured to store such items on shelves disposed within the dispenser, or on moveable carts that can be wheeled into and out of an interior area of a dispenser. To prevent access to the stored items, the dispensers may include a lockable access door configured for being opened by an authorized user.

Prior dispensers, such as those described in U.S. Patent Publication Number 2013/0211585 (application Ser. No. 13/397,196) entitled “Item Dispensing Apparatus” (“the '585 publication”), have included a laterally sliding access door configured to unlock in response to input received from an authorized user via a control system user interface. When unlocked, the laterally sliding access door can be slid open by an authorized user to provide access to items stored in the dispenser. When locked, the laterally sliding access door prevents access by unauthorized users to items stored in the dispenser. The '585 publication also notes that certain embodiments of these dispensers may include shelving or other item storage features integrated into the interior of the dispenser, while other embodiments may be configured for receiving and securely storing removable storage carts. As disclosed in U.S. Patent Publication Number 2008/0272565 (application Ser. No. 11/849,332) entitled “Apparatus for Inserting a Cart, Such as a Cart with one or more Fixed Wheels, into an Enclosure,” dispensers adapted for use with removable storage carts may also include a wheel guide apparatus, wheel support mechanism, or guide arm to assist in guiding a removable cart into such dispensers.

However, given increasing market pressures to improve operational efficiency and reduce shrinkage, there is an ongoing need in the art for dispensers with improved security features and enhanced theft prevention capabilities. Additionally, there is an ongoing need for such dispensers to remain easy for authorized users to access and interact with. As energy conservation and efficient use of space are also high priorities in many industries, there is a further need for such dispensers consume low amounts of power during operation and retain an efficient footprint. Furthermore, in view of increasing efforts to reduce operational cost, there is also a need for dispensers that are more reliable and that can be manufactured at a lower cost.

### BRIEF SUMMARY OF THE INVENTION

Various embodiments of the present invention are directed to a dispenser for storing a moveable cart having a plurality of wheels and a cart body configured or storing one or more items. In various embodiments, the dispenser comprises a housing comprising one or more housing walls defining an access opening and an interior area dimensioned for receiving the moveable cart; an access door disposed adjacent the access opening, the access door configured for movement between (i) a closed position in which the access door prevents access to the cart when the cart is stored within the interior area of the housing and (ii) an open position in which the access door permits access to the cart when stored within the interior area of the housing; and a cart guide apparatus positioned substantially within the housing, the cart guide apparatus comprising one or more guide walls configured to engage the cart body and guide the moveable cart to a loaded position within the interior area of the housing, wherein the one or more guide walls permit a user to move the moveable cart into the interior area of the housing without engaging the one or more housing walls.

In addition, various embodiments of the present invention are directed to a method of inserting a moveable storage cart into a dispenser. In various embodiments, the moveable storage cart comprises a cart body, one or more front wheels disposed adjacent a front portion of the cart body, and one or more rear wheels disposed adjacent a rear portion of the cart body, while the dispenser comprises a housing, including one or more housing walls defining an access opening and an interior area, and a cart guide apparatus comprising one or more guide walls positioned substantially within the housing. According to various embodiments, the method of inserting the storage cart into the dispenser comprises the steps of: moving the cart into a first position in which the cart body is oriented at an angle to the housing's access opening; rolling the cart from the first position to a second position in which the front portion of the cart body is inserted within the interior area of the housing and engages one or more of said one or more guide walls; and rotating the cart from the second position to a third position in which the cart is positioned within the interior area of the housing, the step of rotating the cart comprising rotating the cart about at least one of its one or more front wheels until the rear portion of the cart engages one or more of said one or more guide walls.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a perspective view of a dispenser having an access door in an open position according to one embodiment of the present invention;

FIG. 2 shows a perspective view of a dispenser having an access door in a closed position according to one embodiment of the present invention;

FIG. 3 shows a perspective view of an upper portion of an access door according to one embodiment of the present invention;

FIG. 4 shows a perspective view of a lower portion of an access door according to one embodiment of the present invention;

FIG. 5 shows an interior perspective view of an access door, an upper sliding assembly, and an upper locking mechanism according to one embodiment of the present invention;

FIG. 6 shows an interior perspective view of an access door and a lower locking mechanism according to one embodiment of the present invention;

FIG. 7 shows an interior perspective view of an access door in a closed position and a lower locking mechanism in an engaged configuration according to one embodiment of the present invention;

FIGS. 8A & 8B show a perspective view of an upper locking mechanism, a biasing system, and an upper sliding assembly according to one embodiment of the present invention;

FIG. 9 shows an interior perspective view of a biasing system, an upper sliding assembly, and an open locking mechanism according to one embodiment of the present invention;

FIG. 10 shows a perspective view of a dispenser having an access door in an open position and a security bar in a retention position according to one embodiment of the present invention;

FIG. 11 shows a perspective view of a dispenser having an access door in a closed position according to one embodiment of the present invention;

FIG. 12 shows a perspective view of a dispenser having an access door in an open position and a security bar in an access position according to one embodiment of the present invention;

FIG. 13 shows a perspective view of a dispenser security bar according to one embodiment of the present invention;

FIG. 14 shows a perspective view of an access door, a security bar, and a support leg according to one embodiment of the present invention;

FIG. 15a shows a perspective view of a stopper according to one embodiment of the present invention;

FIG. 15b shows a perspective view of a support leg included on a security bar and a stopper according to one embodiment of the present invention;

FIG. 16 shows a perspective view of a retaining leash according to one embodiment of the present invention;

FIG. 17 shows an interior perspective view of a lower portion of an access door, a portion of a security bar, and a lower locking mechanism according to one embodiment of the present invention;

FIG. 18 shows an interior perspective view of a lower portion of an access door in a closed position, a portion of a security bar, and a lower locking mechanism in an engaged configuration according to one embodiment of the present invention;

FIG. 19 shows a perspective view of a plurality of guide walls and wheel support according to one embodiment of the present invention;

FIG. 20 shows a perspective view of a plurality of guide walls and wheel support according to one embodiment of the present invention;

FIG. 21 shows the outline of a moveable storage cart according to one embodiment of the present invention;

FIG. 22 shows the outline of a storage cart being guided into the dispenser such that the front wheels of the cart are in the dispenser according to one embodiment of the present invention;

FIG. 23 shows the outline of a storage cart being guided into the dispenser such that the front wheels of the cart are in the dispenser and the rear wheels of the cart are aligned for insertion into the dispenser according to one embodiment of the present invention;

FIG. 24 shows the outline of a storage cart being guided into the dispenser such that the cart is nearly in a loaded position according to one embodiment of the present invention;

FIG. 25 shows the outline of a storage cart in a loaded position within a dispenser according to one embodiment of the present invention; and

FIG. 26 shows a top sectional view of a moveable storage cart according to one embodiment of the present invention.

### DETAILED DESCRIPTION OF THE INVENTION

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

### Overview

Various embodiments of the present invention are directed to a dispenser configured for storing one or more items and dispensing the stored items to authorized users. According to various embodiments, the dispenser generally includes a housing comprising one or more housing walls defining an interior area dimensioned to receive one or more items. As an example, the interior area may include one or more shelves configured for supporting a plurality of items, or may define an open space dimensioned to receive a movable storage cart configured for supporting a plurality of items. In order to provide selective access to items within the dispenser, various embodiments of the dispenser include a movable access door configured for being moved to an open position, in which a user has access to items stored within the dispenser, and a closed position, in which a user is prevented from accessing items stored within the dispenser.

As described in greater detail herein, the dispenser's access door is configured to enable an authorized user to more easily access items stored within the dispenser. For example, in various embodiments, the access door includes a flexible barrier and is configured to slide in a lateral direction relative to the dispenser's housing such that an authorized user can easily adjust the access door to the open or closed position. As described in detail below, various embodiments of the dispenser also include an upper locking mechanism and a lower locking mechanism configured to enhance the ability of the access door to resist being forcibly opened from its closed position by unauthorized users. Additionally, various embodiments of the dispenser may also include a movable security bar configured for being moved between a closed position, in which the security bar prevents insertion or removal of a movable storage cart, and an open position, in which the security bar does not prevent insertion or removal of a movable storage cart.

Furthermore, embodiments of the dispenser configured for receiving a movable storage cart may include a plurality of interior guide walls configured to engage the body of a storage cart as it is moved into the dispenser and thereby guide the cart into a loaded position in the dispenser. As described in greater detail below, the guide walls prevent the cart from contacting and potentially damaging the housing walls of the dispenser, while also guiding the cart into the dispenser without relying fully on contact with more vulnerable components of the cart (e.g., such as the wheels).

As will be appreciated from the following description, these features—as well as various other aspects of the dispenser described herein—improve the theft prevention capabilities of the dispenser and enhance the usability characteristics of the dispenser while also ensuring that the dispenser is comprised of low-cost, reliable components that improve reliability and reduce overall manufacturing cost.

Dispenser with Integrated Item Support Features

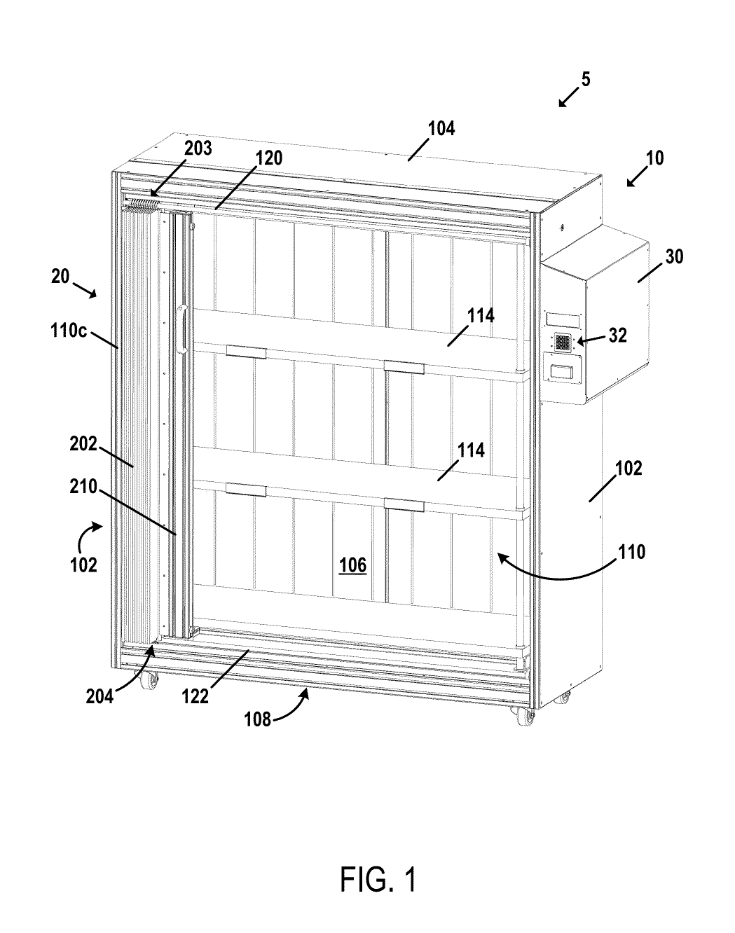

FIG. 1 illustrates a dispenser 5 according to one embodiment. As shown in FIG. 1, the dispenser 5 generally includes a housing 10, an access door 20, and a control system 30. As described in greater detail below, the access door 20 is configured to slide laterally relative to the housing 10 in order to prevent or permit access to an interior area of the housing 10 configured for storing one or more items. To restrict access to authorized users only, the control system 30 is generally configured to control locking mechanisms configured to lock and unlock the access door 20 based on input received from a user.

In the illustrated embodiment of FIG. 1, the housing 10 comprises a plurality of housing walls, including a first and second lateral side wall, an upper wall, a lower wall, and a rear wall. As shown in FIG. 1, the first and second lateral wall may comprise a pair of side panels 102, the upper wall may comprise an upper panel 104, the lower wall may comprise a bottom panel 108, and the rear wall may comprise a rear panel 106. According to various embodiments, the side panels 102, the upper panel 104, and the rear panel 106 may be formed from any suitable structural material (e.g., metal or high-strength plastics). The side panels 102, the upper panel 104, the rear panel 106, and the bottom panel 108 may comprise separately connected components, or may be formed from a single piece of shaped structural material. In certain embodiments, the panels 102-108 may be load-bearing, structural components of the housing 10. However, in other embodiments, the panels 102-108 may be non-load-bearing, thin sheets configured to cover load-bearing, structural housing frame members.

As shown in FIG. 1, the components 102-106 define an interior area accessible through an access opening 110. In the illustrated embodiment, the interior area includes a plurality shelves 114, which may be substantially rectangular, oriented horizontally, and vertically spaced from one another. The shelves 114 are configured to function as item support features for supporting a plurality of items disposed in the interior area of the housing 10. For example, when configured for application in the healthcare industry, the shelves 114 can support various linens, scrubs, or the like. However, as will be appreciated from the description herein, various other item support features may be provided in the interior area of the housing 10 in addition to, or in place of, the shelves 114. For example, in certain embodiments, various slots or cubby holes dimensioned for receiving items are disposed in the interior area of the housing 10. In addition, certain embodiments of the dispenser 5 may not include item support features within the housing's interior area.

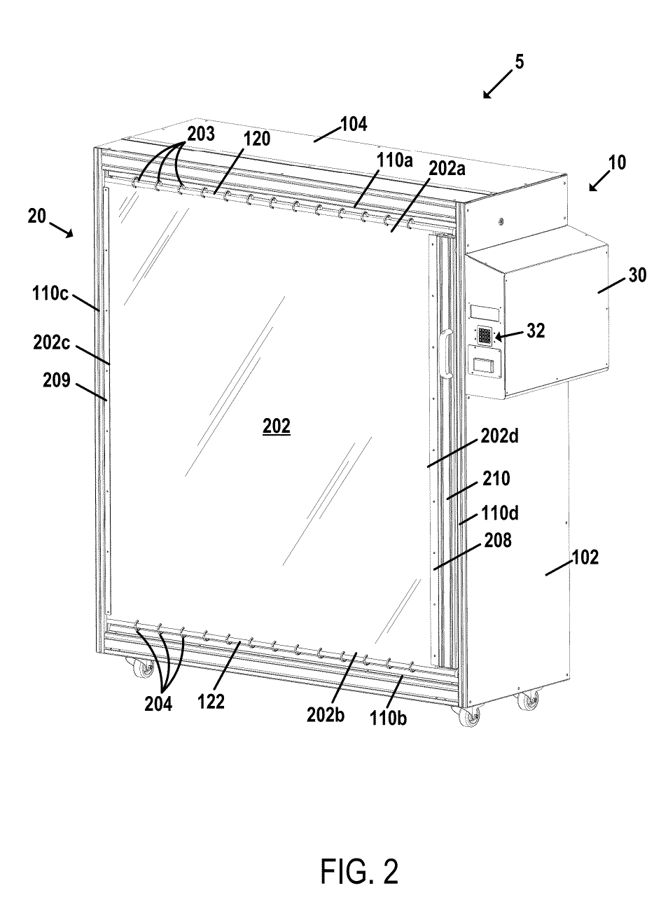

According to various embodiments, the access door 20 is operatively connected to the housing 10 adjacent the housing's access opening 110. As described in greater detail below, the access door 20 is configured to slide laterally between an open position, in which the access door 20 permits access to items stored within the interior area of the housing 10, and a closed position, in which the access door 20 prevents access to items stored within the interior area of the housing 10. For example, FIG. 1 illustrates the access door 20 in an open position according to one embodiment, while FIG. 2 illustrates the access door 20 in a closed position according to one embodiment.

In the illustrated embodiment of FIGS. 1 and 2, the access door 20 comprises a flexible barrier 202 and a vertical support member 210. According to various embodiments, the flexible barrier 202 may comprise a fabric sheet made from a tear-resistant material (e.g., ballistic nylon, polyester, Kevlar® fabric). However, as will be appreciated from the description herein, the flexible barrier may be formed from any flexible material of suitable durability and strength. In addition, as used herein, the terms “vertical” and “horizontal” are intended to refer to components oriented generally vertically or generally horizontally. Although such components may be oriented exactly vertically or horizontally with respect to a support surface, the terms vertical and horizontal are not intended to indicate that such an exact orientation is required.

As shown in FIG. 2, the upper and lower edges 202a, 202b of the flexible barrier 202 are operatively connected to the housing 10 by a first plurality of door attachment members comprising a first set of rings 203 and a second plurality of door attachment members comprising a second set of rings 204. The first set of rings 203 are disposed along the flexible barrier's upper edge 202a and are engaged with an upper horizontal support member comprising an upper horizontal guide rod 120. Likewise, the second set of rings 204 are disposed along the flexible barrier's lower edge 202b and are engaged with a lower horizontal support member comprising a lower horizontal guide rod 122. In the illustrated embodiment of FIG. 2, the upper and lower horizontal guide rods 120, 122 extend across the width of the housing's access opening 110 and are connected to the housing 10 adjacent the access opening's upper perimeter 110a and lower perimeter 110b, respectively. As will be appreciated from the description herein, the upper and lower horizontal guide rods 120, 122 may comprise separate rod members attached to the housing 10, or may comprise rod members formed from a portion of the housing 10 itself. Together, the rings 203, 204 and the horizontal guide rods 120, 122 function to secure the flexible barrier 202 to the housing 10 such that the flexible barrier 202 extends substantially across the height of the access opening 110 and is laterally movable between the aforementioned open and closed positions.

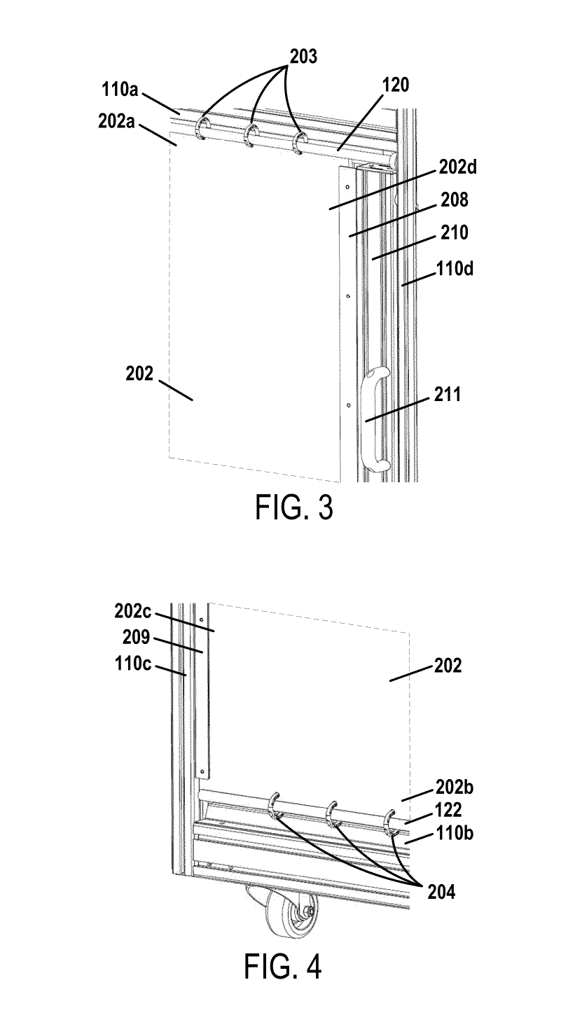

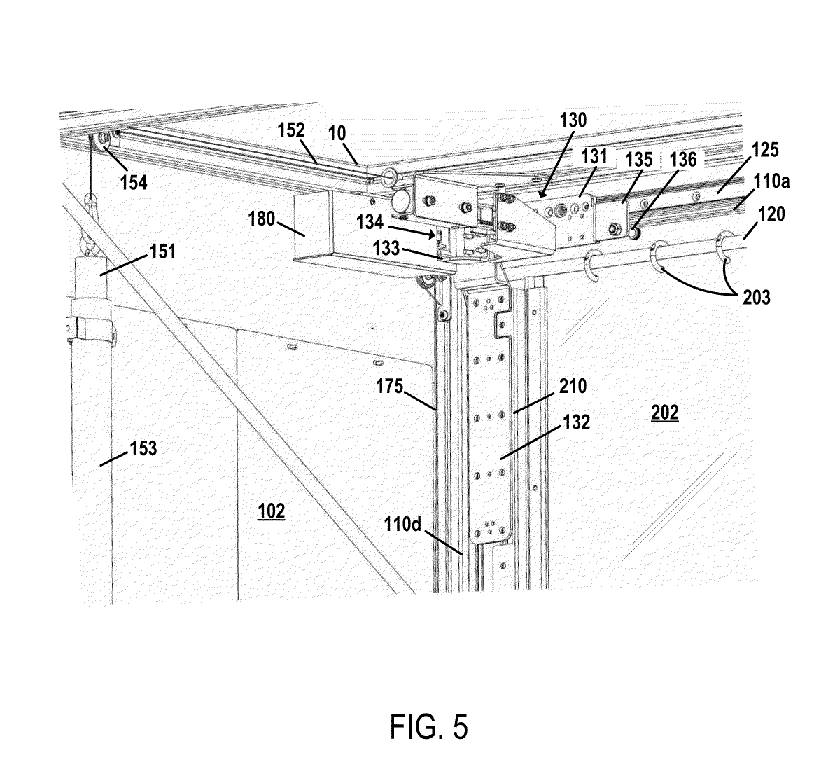

FIG. 3 shows an exterior view of an upper portion of the flexible barrier 202 and the first set of rings 203. In the illustrated embodiment, each of the rings 203 extends around the upper horizontal guide rod 120 such that it may slide laterally along the upper horizontal guide rod 120. In addition, each of the rings 203 extends through a hole in the flexible barrier 202 such that, together, the rings 203 operatively connect the upper edge 202a of the flexible barrier 202 to the upper horizontal guide rod 120. Similarly, FIG. 4 shows an exterior view of a lower portion of the flexible barrier 202 and the second set of rings 204. As shown in FIG. 4, each of the rings 204 extends around the lower horizontal guide rod 122 such that it may slide laterally along the lower horizontal guide rod 122. In addition, each of the rings 204 extends through a hole in the flexible barrier 202 such that, together, the rings 204 operatively connect the lower edge 202b of the flexible barrier 202 to the lower horizontal guide rod 122.

Referring back to FIG. 2, the flexible barrier 202 is also attached along its side edges 202c, 202d to the housing 10 and vertical support member 210, respectively. In the illustrated embodiment of FIG. 2, the vertical support member 210 comprises a generally elongated member slidably connected to the housing 10 and oriented substantially vertically such that it extends across the full height of the access opening 110. In various embodiments, the vertical support member 210 is generally rigid and comprised of a high-strength material, such as steel, aluminum, or high-strength composite or alloy materials. However, as will be appreciated from the description herein, the vertical support member 210 may be comprised of various materials of suitable strength and rigidity. In various embodiments, the vertical support member 210 is configured to slide laterally relative to the housing 10 in order to permit the access door 20 to move between its open and closed positions. For example, in the open position shown in FIG. 1, the vertical support member 210 is positioned adjacent a first lateral side 110c of the housing's access opening 110. To adjust the access door 20 to its closed position shown in FIGS. 2 and 3, the vertical support member 210 can be moved laterally toward the access opening's opposite, second lateral side 110d. In addition, in the illustrated embodiment of FIG. 3, the vertical support member 210 includes a handle 211 configured to enable a user to easily adjust the position of the vertical support member 210.

As shown in FIG. 2, a first side edge 202c of the flexible barrier is attached to the housing 10 adjacent the first lateral side 110c of the access opening 110. As shown in FIG. 4, the flexible barrier's first side edge 202c is clamped between a C-shaped attachment member 209 secured to the housing 10 along the access opening's first lateral side 110c. However, as will be appreciated from the description herein, the flexible barrier's first side edge 202c can be attached to the housing 10 with various other attachment devices or methods (e.g., using an adhesive or a plurality of fastening devices).

In addition, a second side edge 202d of the flexible barrier 202 is attached to the vertical support member 210. In particular, in the illustrated embodiment of FIG. 3, the flexible barrier's second side edge 202d is clamped between a C-shaped attachment member 208 secured to the vertical support member 210. However, as will be appreciated from the description herein, the flexible barrier's second side edge 202d can be attached to the vertical support member 210 with various other attachment devices or methods (e.g., using an adhesive or a plurality of fastening devices).

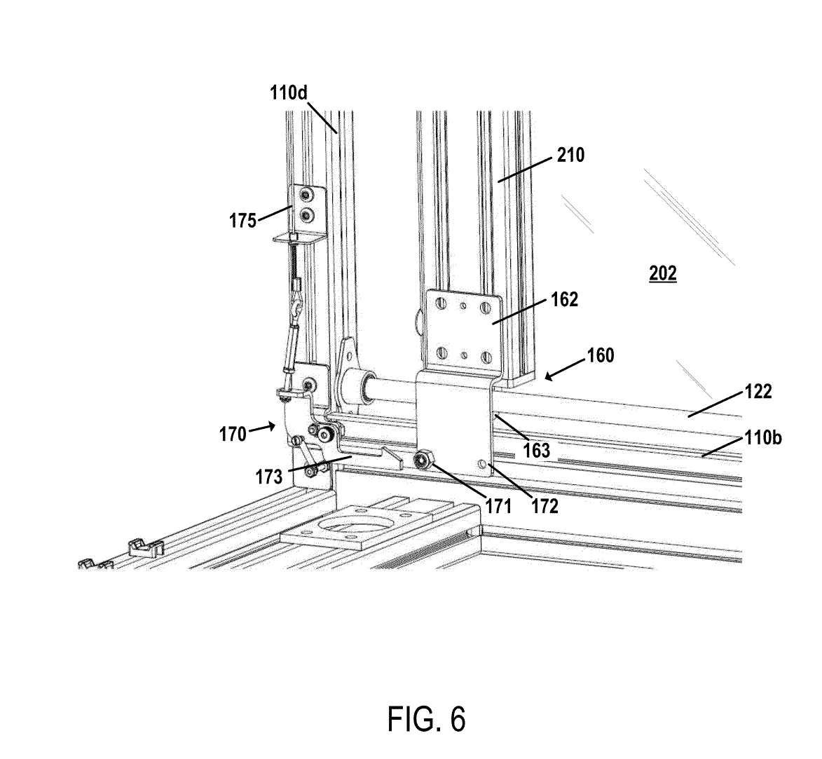

In the illustrated embodiment of FIGS. 1 and 2, the vertical support member 210 is slidably connected to the housing 10 at its upper end by an upper sliding assembly 130, and its lower end by a lower sliding assembly 160. FIG. 5 shows an upper portion of the vertical support member 210 as viewed from the interior area of the housing 10 according to one embodiment. As shown in FIG. 5, the upper portion of the vertical support member 210 is operatively connected to the upper sliding assembly 130 by an upper bracket 132. The upper sliding assembly 130 comprises a body portion 131 configured to slide laterally along a second upper horizontal support member comprising an upper guide rail 125. In various embodiments, the upper guide rail 125 is disposed on an interior area of the housing 10 slightly above the access opening's upper perimeter 110a and extends substantially horizontally across the housing 10 such that it spans the width of the access opening 110. The body portion 131 of the upper sliding assembly 130 includes a bearing block configured to engage the upper guide rail 125 such that the upper sliding assembly 130 can slide smoothly along the upper guide rail 125. In various embodiments, the bearing block and upper guide rail 125 may comprise a commercially available rail and slide unit (e.g., a Rollon TLV28 Rail and Rollon NTE28 Slider).

As described in greater detail below in relation to the access door's locking mechanisms, the upper sliding assembly 130 also includes a forward projection 133 configured for supporting a first upper locking bolt 134, and a rearward projection 135 configured for supporting a second upper locking bolt 136 (shown in FIGS. 5, 8, and 9). Additionally, the upper sliding assembly 130 further comprises a connecting member 158 and a door check receiver 137. As described in greater detail below, the upper sliding assembly 130 is configured to engage locking mechanisms 180, 190 disposed on the housing 10 in order to enable the access door 20 to be locked in an open or closed position.

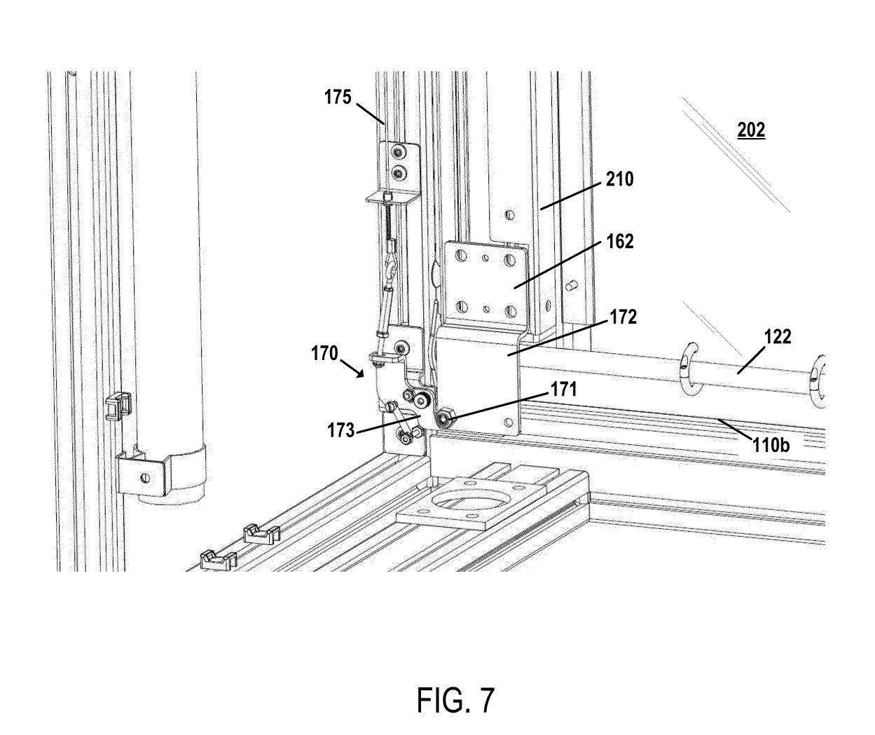

FIG. 6 shows a lower portion of the vertical support member 210 as the access door 20 is approaching the access opening's second lateral side 110d viewed from the interior area of the housing 10 according to one embodiment. As shown in FIG. 6, the lower portion of the vertical support member 210 is operatively connected to the lower sliding assembly 160 by a lower bracket 162. The lower sliding assembly 160 comprises a protector plate 172, which extends first inwardly and then downwardly from the lower bracket 162, and a bored member 163 defined beneath the vertical support member 210 proximate the vertex of the protector plate 172. The sliding assembly 160 is positioned such that the lower horizontal guide rod 122 extends through a bore in the bored member 163, thereby serving as a guide for the lower portion of the vertical support member 210 as it slides laterally along the lower horizontal guide rod 122. According to various embodiments, the bored member 163 may be formed from a low-friction, bearing-grade plastic (e.g., acetal). As described in greater detail below in relation to the access door's locking mechanisms, the lower sliding assembly 160 also includes a lower locking bolt 171, which is supported horizontally by a lower portion of the protector plate 172.

As noted above, the vertical support member's 210 ability to slide laterally along the upper guide rail 125 and the lower horizontal guide rod 122 enables the access door 20 to be adjusted between an open and closed position. As noted above, FIG. 2 illustrates the access door 20 in a closed position according to one embodiment. With the access door 20 in the closed position of FIG. 2, the access door's flexible barrier 202 substantially spans the height and width of the housing's access opening 110. As such, items disposed within the interior area of the housing 10 are inaccessible to users outside of the dispenser 5 with the access door 20 in the closed position. In particular, in the closed position of FIG. 2, the vertical support member 210 is positioned against the housing 10 adjacent the access opening's second lateral side 110d and the flexible barrier's second side edge 202d is secured along the vertical support member 210. On the opposite side, the flexible barrier's first side edge 202c is secured to the housing 10 adjacent the access opening's first lateral side 110c. Thus, in the closed position of FIG. 2, there is no space for a human hand of average size to access the interior area of the housing 10 along the flexible barrier's side edges 202c, 202d.

In addition, in the illustrated embodiment of FIG. 2, the rings 203, 204 are spaced apart along the flexible barrier's upper and lower edges 202a, 202b such that, when the flexible barrier 202 is outstretched in the closed position of FIG. 2, the rings 203, 204 are spaced apart from one another at distance that prevents a human hand of average size from fitting between the rings 203, 204. Likewise, in the illustrated embodiment of FIG. 2, the access opening's upper and lower perimeters 110a, 110b, the upper and lower horizontal guide rods 120, 122, and the flexible barrier's upper and lower edges 202a, 202b are positioned proximately to one another such that a human hand of average size cannot be inserted between them and into the interior area of the housing 10. Thus, in the closed position of FIG. 2, there is no space for a human hand of average size to access the interior area of the housing 10 along the flexible barrier's upper and lower edges 202a, 202b.

As noted earlier, FIG. 1 illustrates the access door 20 in an open position in which the access door's vertical support member 210 is moved laterally toward the access opening's first lateral side 110c. With the vertical support member 210 moved to the position of FIG. 1, the flexible barrier 202 is compressed into a plurality of folds and does not obstruct access to the interior area of the housing 10 through the access opening 110.

According to various embodiments, the aforementioned components of the access door 20 enable the access door 20 to be easily moved by a user between the open and closed positions of FIGS. 1 and 2. In particular, in the illustrated embodiment of FIGS. 1-7, the upper and lower guide rods 120, 122; rings 203, 204; upper guide rail 125; upper sliding assembly 130; and lower sliding assembly 160 provide a low-friction system for sliding the access door 20 between its open and closed positions. In addition, the flexible barrier 202 and vertical support member 210 enable the access door 20 to be relatively light weight, further reducing the effort necessary to move the access door 20. Moreover, the laterally sliding nature of the access door 20 enables a user to move the access door from a comfortable position.

According to various embodiments, the dispenser 5 also includes a biasing system configured to bias the access door 20 to the closed position of FIG. 2. As an example, FIGS. 5, 8, and 9 illustrate various aspects of the dispenser's biasing system according to one embodiment. In particular, FIG. 5 shows a portion of the dispenser's biasing system as viewed from a rear, interior area of the housing 10. As shown in FIG. 5, the biasing system generally comprises a counterweight 151 operatively connected to the upper sliding assembly 130 by a wire 152. A first end of the wire 152 is connected to the counterweight 151, which comprises an elongated cylindrical member (e.g., a three pound steel cylinder) configured to move substantially vertically as it is lowered and raised by the wire 152. To prevent the counterweight 151 from contacting items stored within the dispenser, the counterweight 151 is configured to move vertically in and out of a tubular member 153 secured to an interior corner of the housing 10. As can be seen in FIG. 5, the counterweight 151 and tubular member 153 are positioned adjacent the housing's side panel 102 nearest to the access opening's second lateral side 110d. In various embodiments, the positioning and slim profile of the counterweight 151 and tubular member 153 enable the biasing system to encompass a small amount of space within the housing 10.

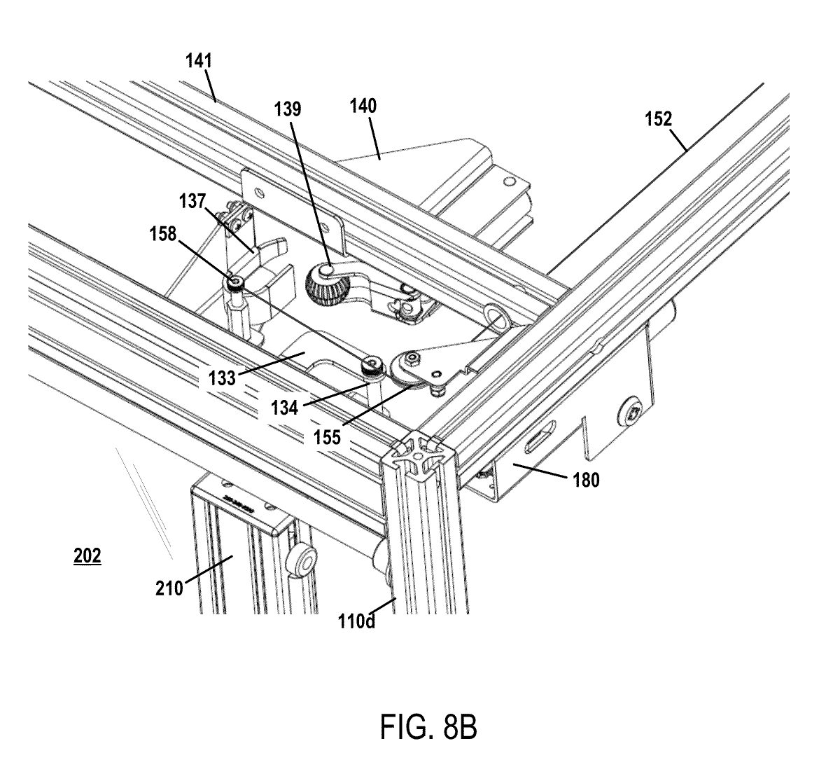

In the illustrated embodiment of FIG. 5, the wire 152 extends vertically upward from the counterweight 151, around a first pulley 154, and horizontally just below the top of the housing 10. FIG. 8B illustrates another portion of the dispenser's biasing system as viewed from above the housing 10. As shown in FIG. 8B, the wire 152 is threaded around a second pulley 155 and is attached to the upper sliding assembly's connecting member 158. In this way, the counterweight 151 applies a downward force on the wire 152 that pulls the upper sliding assembly 130 toward the access opening's second lateral side 110d (i.e., toward the access door's closed position).

In various embodiments, the upper sliding assembly 130 also includes a door check mechanism 139 configured to provide a smooth, damped, and controlled movement of the access door 20 as it approaches its closed position. As shown in FIG. 8B, the door check mechanism 139 is secured to a door check bracket 140 connected to a medial upper frame member 141 of the housing 10. In the illustrated embodiment, the door check mechanism 139 comprises a ball rotatably connected to a pair of pivotable arms. The door check mechanism's ball is generally configured to engage the upper sliding assembly's door check receiver 137. In the illustrated embodiment of FIG. 8B, the door check receiver 137 comprises a C-shaped member extending outwardly from the upper sliding assembly's body portion 131 and defining an opening dimensioned for catching the door check mechanism's ball. According to various embodiments, the door check mechanism 139 may comprise a commercially available door check mechanism (e.g., a Dictator 1113127).

As can be appreciated from FIG. 8B, as the upper sliding assembly 130 approaches the second lateral side 110d of the housing's access opening (i.e., its closed position), the door check mechanism 139 engages the door check receiver 137. According to various embodiments, when moved in the closing direction of the access door 20, the door check mechanism 139 is configured to initially provide damped resistance as the upper sliding assembly 130 moves toward the access door's closed position. The door check mechanism 139 then slowly pulls the upper sliding assembly 130 adjacent the second lateral side 110d of the housing's access opening in order to close the access door 20. This functionality of the door check mechanism 139 ensures that the access door 20 is always moved to the closed position is a controlled manner, as well as ensuring that the access door 20 is fully closed anytime the access door is moved proximate the second lateral side 110d of the access opening 110. When moved in the open direction of the access door 20, the door check mechanism 139 may be configured to provide a different level of resistance to enable low-effort opening of the access door 20 (e.g., for improved convenience) or high-effort opening of the access door 20 (e.g., to ensure the access door 20 is only opened deliberately by a user).

According to certain embodiments, the aforementioned components of the dispenser's biasing system apply a closing force to the access door 20 such that, if a user opens the access door 20 and releases the access door 20 without securing it in an open position (e.g., via the open locking mechanism 190 described below), the access door 20 will automatically move to the closed position shown in FIG. 2 (e.g., initially being pulled shut by the biasing system and then moved to the closed position by the door check mechanism 139). As discussed above, the biasing system's door check mechanism controls the speed with which the access door 20 moves towards the closed position. Accordingly, in certain embodiments, the door check mechanism 139 may be configured to reduce the access door's closing speed such that a human hand caught between the housing 10 and the closing access door 20 would not be harmed.

As will be appreciated from the description herein, certain embodiments of the dispenser 5—such as those including the aforementioned biasing system—may not include a powered motor. In such embodiments, the overall energy consumption and power efficiency of the dispenser 5 is improved due to the lack of a powered motor. In addition, the overall reliability and manufacturing cost of the dispenser 5 can be improved due to the simple, reliable components comprising the biasing system. Moreover, the lack of a powered motor enables a more compact design with a higher interior-capacity-to-footprint ratio as the dispenser 5 does not take up space housing a motor assembly.

In other embodiments, however, a powered motor may be provided in place of, or in addition to, the biasing system and/or door check mechanism. In such embodiments, the low-friction, light weight, laterally sliding access door design of FIGS. 1-7 may be incorporated such that a relatively low power motor may be used. This also improves power consumption, reliability, manufacturing cost, and footprint efficiency.

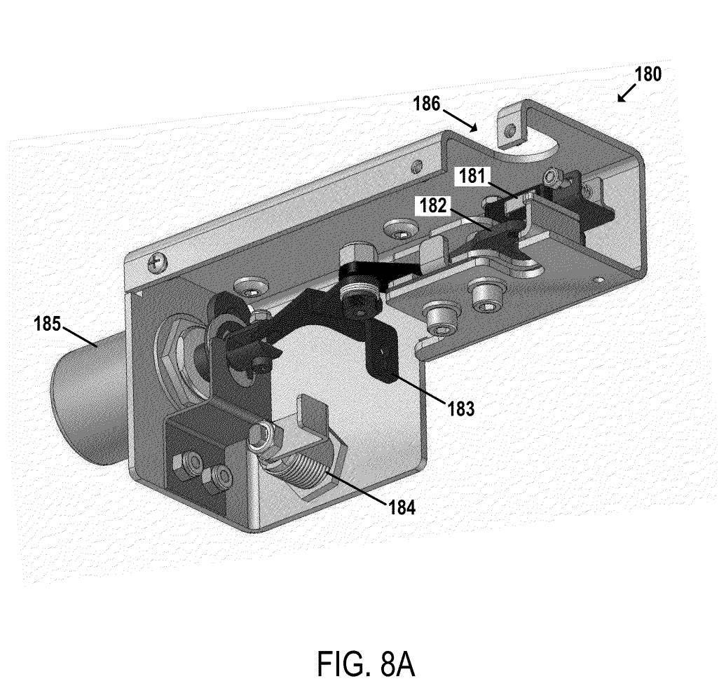

Various embodiments of the dispenser 5 also include a lower locking mechanism 170, an upper locking mechanism 180, and an open locking mechanism 190. Generally, the lower locking mechanism 170 and the upper locking mechanism 180 together serve to selectively lock the access door 20 in its closed position, while the open locking mechanism 190 serves to selectively lock the access door 20 in its open position. The lower locking mechanism 170, which is shown in FIGS. 6 and 7, is secured to an interior area of the housing 10 adjacent the intersection of the access opening's lower perimeter 110b and second lateral side 110d. In the illustrated embodiment, the lower locking mechanism 170 includes a latch 173, which is pivotably connected to the housing 10, and a wire 175, which connects the latch 173 to a lower latch release component 183 in the upper locking mechanism (discussed in greater detail herein).

As can be appreciated from FIGS. 6 and 7, the latch 173 is configured to engage the lower locking bolt 171 supported by the lower sliding assembly's protector plate 172. In particular, the lower locking mechanism 170 is configured such that, when the access door 20 is moved to its fully closed position as shown in FIG. 7, the lower locking mechanism's latch 173 engages the lower locking bolt 171 and prevents the access door 20 from being moved out of its closed position. In this way, the lower locking bolt 171 functions as a locking member for engaging the lower locking mechanism 170. As can be appreciated from FIG. 7, the protector plate 172 also serves to shield from the latch 173 from being inadvertently damaged or deliberately tampered with. In certain embodiments, the lower locking mechanism 170 is configured such that—when the access door 20 is moved to the closed position by the biasing system (e.g., without being manually pushed closed)—the access door 20 will close on its own with a force sufficient to cause the lower locking bolt 171 to automatically engage the lower locking mechanism's latch 173 and secure the access door 20 in the closed position. In such embodiments, a user may lock the access door 20 in its closed position simply by releasing the access door 20 and allowing the biasing system to automatically move the access door 20 to the closed position.

The upper locking mechanism 180 is shown in FIGS. 5, 8A, and 8B. As shown in the illustrated embodiment of FIG. 5, the upper locking mechanism 180 is secured to an interior area of the housing 10 adjacent the intersection of the access opening's upper perimeter 110a and second lateral side 110d. FIG. 8A provides a more detailed cut-away view of the upper locking mechanism 180. In the illustrated embodiment, the upper locking mechanism 180 includes a housing defining a recessed area 186 dimensioned for receiving the upper sliding assembly's first upper locking bolt 134 and a rotary latch 182 configured for automatically securing and locking the first upper locking bolt 134 when it is received into the recessed area 186. The upper locking mechanism 180 further includes a door-closed switch 181 configured to detect the engagement of the first upper locking bolt 134 with the upper locking mechanism 180.

Like the lower locking mechanism 170, the upper locking mechanism 180 is configured such that, when the access door 20 is moved to its fully closed position, the upper locking mechanism's latch 182 engages the upper locking bolt 134 and prevents the access door 20 from being moved out of its closed position. In this way, the first upper locking bolt 134 functions as a locking member for engaging the upper locking mechanism 180. In certain embodiments, the upper locking mechanism 180 is configured such that—when the access door 20 is moved to the closed position by the biasing system (e.g., without being manually pushed closed)—the access door 20 will close on its own with a force sufficient to cause the first upper locking bolt 134 to automatically engage the upper locking mechanism's latch 182 and secure the access door 20 in the closed position. In such embodiments, a user may lock the access door 20 in its closed position simply by releasing the access door 20 and allowing the biasing system to automatically move the access door 20 to the closed position.

To unlock the access door 20 from the upper locking mechanism 180, the upper locking mechanism 180 also includes a solenoid 185 configured to release the latch 182 when actuated and free the first upper locking bolt 134 from the recessed area 186. As shown in FIG. 8A, the linkage between the solenoid 185 and latch 182 includes a lower latch release member 183. As noted above, the lower latch release member 183 is secured to the wire 175 in order to connect the lower locking mechanism's latch 173. As such, when the solenoid 185 is actuated to release the upper locking mechanism's latch 182, the lower latch release member 183 pulls the wire 175 and releases the lower locking mechanism's latch 173 concurrently. In this way, actuation of the solenoid 185 can unlock the access door 20 from both the upper locking mechanism 180 and the lower locking mechanism 170 at the same time.

As discussed in greater detail below, various embodiments of the upper locking mechanism 180 may be controlled by the dispenser's control system 30. For example, in one embodiment, the control system 30 may be configured to actuate the solenoid 185, thereby controlling unlocking of the upper and lower locking mechanisms 180, 170. Additionally, in the illustrated embodiment of FIG. 8A, the upper locking mechanism 180 includes a key-operated manual release mechanism 184, which is operatively connected to the linkage between the solenoid 185 and the latch 182. As such, a user may insert a key into a keyhole provided on the housing 10 and thereby unlock the upper and lower locking mechanisms 180, 170 by engaging the key and turning the key-operated manual release mechanism 184. In other embodiments, a manually-operated lever or button mechanism configured to mechanically disengage the latch may be used.

According to various embodiments, the lower and upper locking mechanisms 170, 180 may be used in combination to securely lock the access door 20 in its closed position. For example, in one embedment, the lower locking mechanism 170 may be configured such that—as the access door 20 moves to its closed position—the vertical support member's lower locking bolt 171 will engage the lower locking mechanism 170 before the vertical support member's upper locking bolt 134 engages the upper locking mechanism 180. When using both the lower and upper locking mechanism 170, 180 to secure the access door 20 in a the closed position, configuring the lower locking mechanism 170 to engage before the upper locking mechanism 180 decreases the amount of force required to engage the locking mechanisms and move the access door 20 into its fully closed position. This reduces the force necessary to be applied by biasing system and reduces force with which the access door closes, thereby improving safety and enabling the use of lighter and cheaper materials to form the various dispenser components.

Additionally, the provision of locking mechanisms 170, 180 proximate both the upper and lower ends of the vertical support member 210 improves the vertical support member's ability to resist tampering by unauthorized users. For example, where only a single locking mechanism is provided at either the upper or lower end of the vertical support member 210, an authorized user may pull the vertical support member 210 in the access door's opening direction from the end of the vertical support member 210 not having a locking mechanism. This action applies a torque on the vertical support member 210, with the length of the vertical support member 210 acting as a lever on its sole locking mechanism and rendering the locking mechanism vulnerable to being breached or damaged. By providing locking mechanisms 170, 180 at both ends of the vertical support member 210, the ability of the vertical support member 210 to resist opening forces applied by an unauthorized user is enhanced and the theft prevention characteristics of the dispenser 10 are improved.

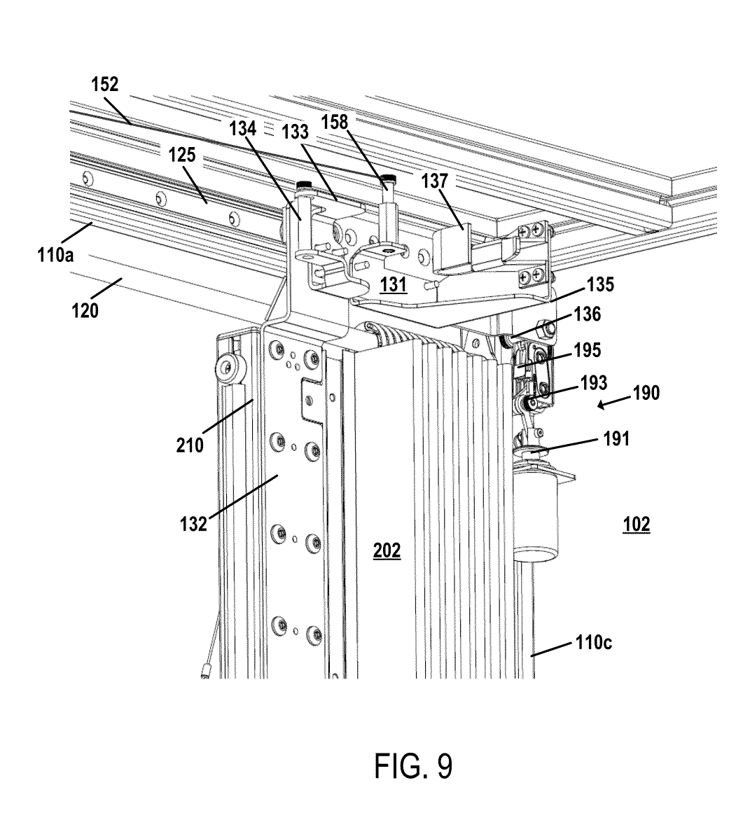

The dispenser's open locking mechanism 190 is shown in FIG. 9. In the illustrated embodiment, the open locking mechanism 190 is secured to an interior area of the housing's side panel 102 adjacent the intersection of the access opening's upper perimeter 110a and first lateral side 110c. The open locking mechanism 190 includes a latch 195 positioned to engage the upper sliding assembly's second upper locking bolt 136. In certain embodiments, the latch 195 is configured such that, when the access door 20 is moved to its fully open position, the open locking mechanism's latch 195 engages the second upper locking bolt 136 and prevents the access door 20 from being moved out of its open position. In such embodiments, a user may lock the access door 20 in its open position simply by pushing the access door 20 to its open position. In this way, the second upper locking bolt 136 functions as a locking member for engaging the open locking mechanism 190.

To unlock the access door 20 from its open position, the open locking mechanism 190 disengages its latch 195 from the upper sliding assembly's second upper locking bolt 136. In various embodiments, this can be accomplished automatically or manually. For example, in the illustrated embodiment of FIG. 9, the dispenser's control system 30 is configured to control the open locking mechanism 190. In particular, in the illustrated embodiment of FIG. 9, the latch 195 is actuated by a solenoid 191 configured to move the latch 195 out of engagement with the second upper locking bolt 136 via a linkage 193. The solenoid 191 is actuated by a control signal generated by the control system 30. Additionally, a lever, button, or keyed mechanism configured to mechanically disengage the latch 195 from the second locking member 136 may be provided on the exterior of the housing 10 to permit manual disengagement of the open locking mechanism 190.

As noted above, the dispenser's control system 30 may be configured to control the locking mechanisms 170, 180, 190. According to various embodiments, the control system 30 generally comprises a computing device (e.g., a processor and memory storage device) configured to interface with one or more user input devices disposed on the exterior of the housing (e.g., a keypad, a card reader, and/or an RFID reader). For example, in the illustrated embodiment of FIGS. 1 and 2, the control system 30 is contained in a small housing on an exterior face of one of the dispenser side walls 102 and includes a user interface 32 comprising a keypad, a card reader, and a display screen. In various embodiments, the locking mechanisms 170, 180, 190 are controlled by one or more solenoids or other electromechanical devices configured to actuate the locking mechanisms' latches in response to a control signal received from the control system 30. Thus, in one embodiment, the control system 30 may be configured to actuate the locking mechanisms' latches to unlock the closed access door 20 in response to receiving valid user input (e.g., a card swipe from a card assigned to an authorized user, or an authorization code entered via the key pad). By preventing the access door 20 from being unlocked by a user unable to provide such valid user input, the control system 30 and locking mechanisms 170, 180 are able to prevent access to items stored in the interior area of the housing 10. In certain embodiments, the locking mechanisms 170, 180 may also include the aforementioned mechanical unlocking system as a redundant back-up method for unlocking the access door 20 when the automated control system 30 fails.

In relation to the open locking mechanism 190, the control system 30 may include a timing function that actuates the solenoid 191 and disengages the latch 195 after a programmed period of time (e.g., where the timing begins when the latch 195 engages the second upper locking bolt 136). In such embodiments, the control system 30 prevents the access door 20 from being left open with the dispenser 5 unattended for an extended period of time.

According to various embodiments, the dispenser's control system 30 may be further adapted to provide various other functionalities. As an example, in certain embodiments, the dispenser 5 may include a scale configured to monitor the weight of items stored in the interior area of the housing 10 (e.g., the total weight of all items stored on the shelves 114). In such embodiments, the control system 30 may be connected to a remote server over a network that is configured to monitor the amount of items present in various dispensers connected over the network. For example, the control system 30 may be adapted for use in an inventory management system such as that disclosed in U.S. application Ser. No. 11/236,214, now U.S. Pat. No. 7,428,447, the entirety of which is herein incorporated by reference.

As will be appreciated from the description provided herein, various modifications to the dispenser 5 may be made within the scope of the present invention. For example, in regard to the plurality of housing walls, these walls may comprise one or more panels, one or more cross bars, a lattice structure, and/or the like. In regard to the flexible barrier's connection to the housing 10, the rings 203, 204 may be connected to the flexible barrier 202 in any suitable fashion (e.g., via loops or rivets disposed along the flexible barrier's upper and lower edges 202a, 202b). In addition, the rings 203, 204 may be replaced by other door attachment members suitable for sliding along the guide rods 120, 122, such as fabric loops or metal hooks. In other embodiments, the guide rods 120, 122 may be replaced with additional guide rails and the flexible barrier 202 may be operatively connected to the additional guide rails by a plurality of bearing blocks connected along the flexible barrier's upper and lower edges 202a, 202b. In other embodiments, the bearing blocks connected to the flexible barrier's upper edge 202a could be configured to move along the upper guide rail 125, along with the upper sliding assembly 130.

According to various embodiments, the vertical support member 210 may also be operatively connected to the housing 10 using a variety of methods. For example, in certain embodiments, the upper end of the vertical support member 210 may be configured to slide along the upper guide rods 120. In other embodiments, the lower end of the vertical support member 210 may be configured to slide laterally along a second lower horizontal support member comprising a lower guide rail. The lower guide rail may be disposed on an interior area of the housing 10 slightly below the access opening's lower perimeter 110b and extends substantially horizontally across the housing 10 such that it spans the width of the access opening 110. The lower sliding assembly may include a bearing block configured to engage the lower guide rail such that the lower sliding assembly can slide smoothly along the lower guide rail (e.g., a bearing block and rail the same as or similar to that disclosed above in relation to the upper sliding assembly 130). In other embodiments, the dispenser 5 may include a pair of vertical support members positioned on both side edges of the flexible barrier 202. In further embodiments, the vertical support member 210—and thereby the access door 20—may be angled such that it is not perpendicular to the support surface on which the dispenser 5 is positioned.

Moreover, as will be appreciated from the description herein, various embodiments of the lower locking mechanism 170, upper sliding assembly 130, and upper locking mechanism 180 may include various other locking devices suitable for securing the access door 20 in its closed position. In addition, the components of the open locking mechanism 190 may be adapted for use in various other embodiments as a lower or upper locking mechanism, and the components of the locking mechanisms 170, 180 may be adapted for use as an open locking mechanism. In embodiments using the lower and upper locking mechanisms 170, 180 in combination, the locking mechanisms 170, 180 may be disengaged individually using features described above, or in combination using a single unlocking feature.

### Dispenser Configured to Receive an Item Supporting Cart

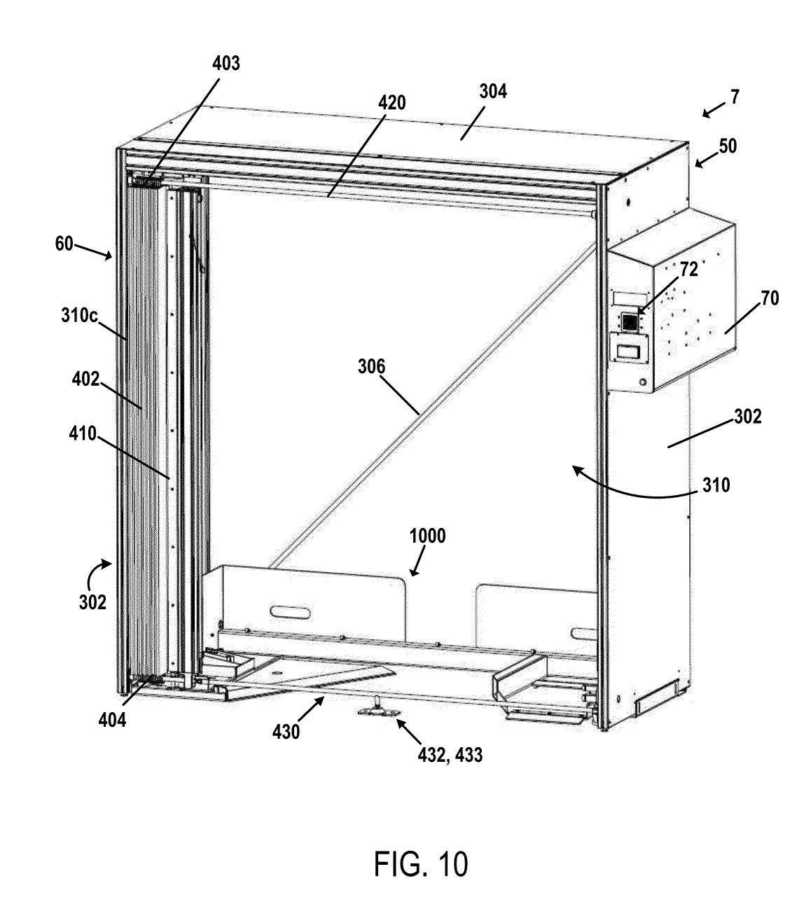

FIGS. 10-12 illustrate a dispenser 7 according to another embodiment of the present invention. As shown in FIGS. 10-12, the dispenser 7 generally includes a housing 50, an access door 60, a cart guide apparatus 1000, and a control system 70. Similarly to the access door 20 shown in the illustrated embodiment of FIGS. 1 and 2, the access door 60 is configured to slide laterally relative to the housing 50 in order to prevent or permit access to an interior area of the housing 50. However, in the illustrated embodiment of FIGS. 10-12, the housing's interior area is dimensioned for receiving a movable storage cart 200 configured for supporting various items, such as the moveable storage cart disclosed in U.S. patent application Ser. No. 11/849,332, now published as U.S. Publication 2008/0272565, the entirety of which is herein incorporated by reference. Accordingly, the housing 50 defines an open lower perimeter configured to permit a movable storage cart to be moved into and out of the housing 50 when the access door 60 is in a fully open configuration. Furthermore, as shown in FIG. 10, the dispenser 7 includes a cart guide apparatus 1000 configured to guide a movable storage cart into the interior area of the housing 50 through the housing's access opening 310 and to secure the movable cart in the interior area of the housing 50.

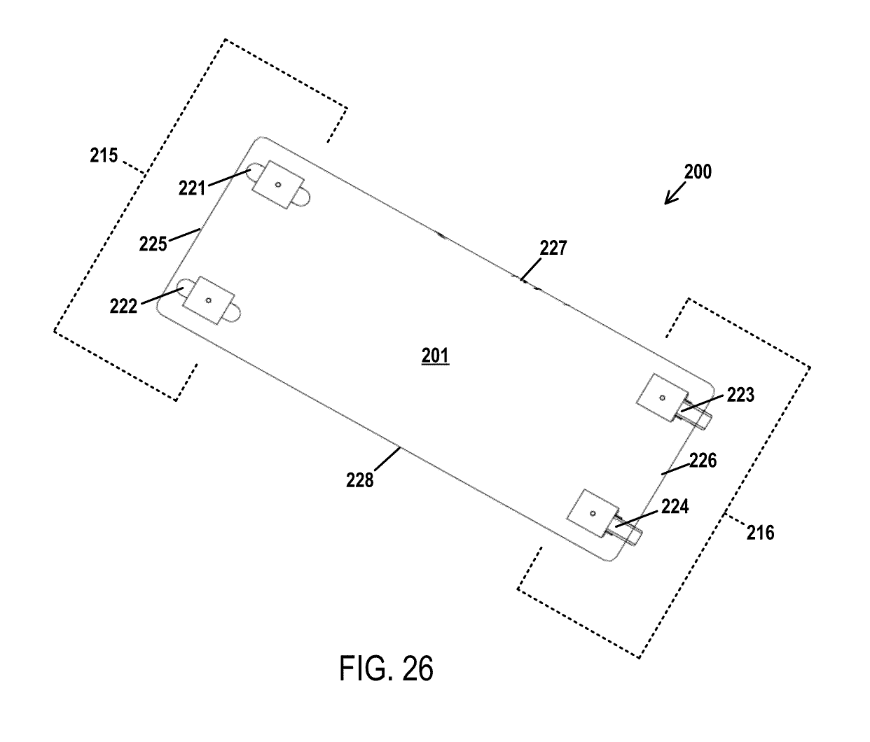

FIG. 26 illustrates a top sectional view of a storage cart 200 according to various embodiments. As shown in FIG. 26, the storage cart 200 comprises a cart body 201 and a plurality of wheels 221-224. The cart body 201 defines a plurality of sides, including a front side 225, a rear side 226, a first lateral side 227 and a second lateral side 228. In the illustrated embodiment, the plurality of wheels comprise a first front wheel 221 and a second front wheel 222 each located adjacent a front portion 215 of the cart body 201. In various embodiments, the front wheels 221, 222 may be non-swiveling, fixed wheels. In the illustrated embodiment, the plurality of wheels further comprise a first rear wheel 223 and a second rear wheel 224, each located adjacent a rear portion 216 of the cart body 201. According to various embodiments, the rear wheels 223, 224 are swiveling wheels.

As will be understood by one skilled in the art, the front portion 215 of the cart body 201 comprises the front side 225 of the cart body 201, as well as at least a portion of the first and second lateral sides 227, 228 located adjacent the front side 225. Similarly, the rear portion 216 of the cart body 201 may comprise the rear side 226 of the cart body, 201, as well as at least a portion of the first and second lateral sides 227, 228 located adjacent the rear side 226. As will be appreciated form FIG. 26, the cart body 201 is generally rectangular and defines a longitudinal axis parallel to the length of the cart 200 and a lateral axis parallel to the width of the cart 200 (and perpendicular to the longitudinal axis). However, as will be understood by one skilled in the art, the dispenser 7 may be adapted for use with carts of various sizes and shapes. For example, in various embodiments the longitudinal axis and lateral axis of the cart 200 may be substantially equivalent in length.

Referring again to the illustrated embodiment of FIGS. 10-12, the housing 50 comprises a plurality of housing walls, including first and second side walls, an upper wall, and a rear wall. As shown in FIGS. 10-12, the first and second side walls comprise a pair of side panels 302, the upper wall comprises an upper panel 304, and the rear wall comprises a cross bar 306. As shown in FIG. 10, the housing walls define an interior area accessible through an access opening 310. As will be appreciated from FIG. 10, when the dispenser 7 is positioned with its rear portion against a building wall (e.g., in the hallway of a hospital), the housing 50 remains able to prevent access to its interior area as the rear cross bar 306 is adjacent the wall.

According to various embodiments, the housing may be formed from any suitable structural material (e.g., metals, plastics, composites, and the like). In particular, the various housing walls 302-306 may comprise separately connected components, or may be formed from a single piece of shaped structural material. In certain embodiments, the housing walls 302-306 may be load-bearing, structural components of the housing 50. However, in other embodiments, the housing walls 302-306 may be non-load-bearing, thin sheets configured to cover load-bearing, structural housing frame members.

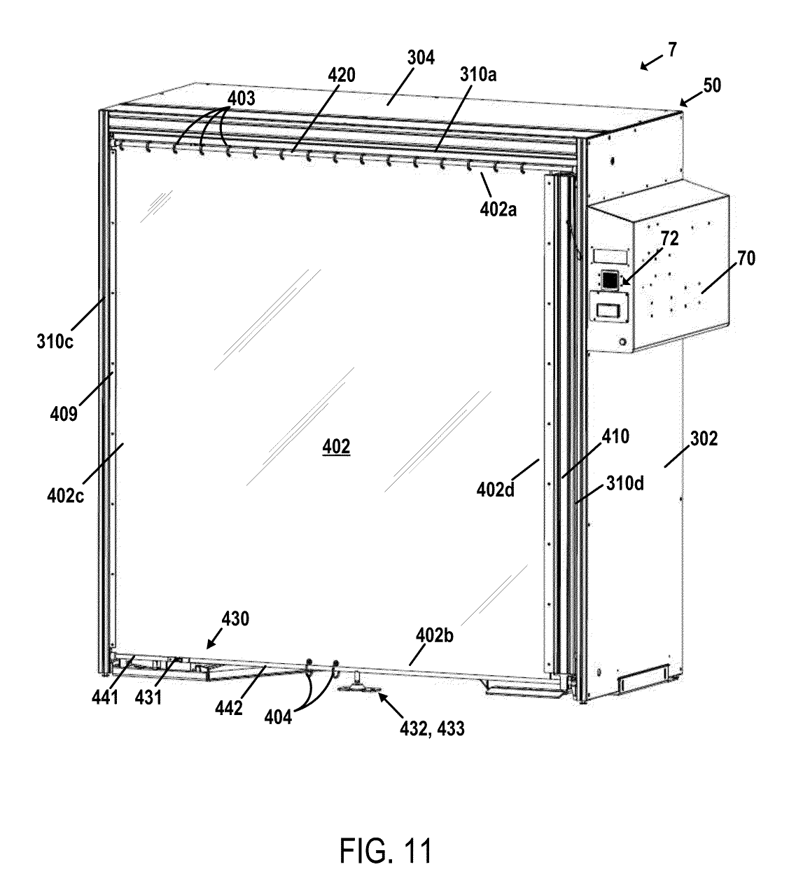

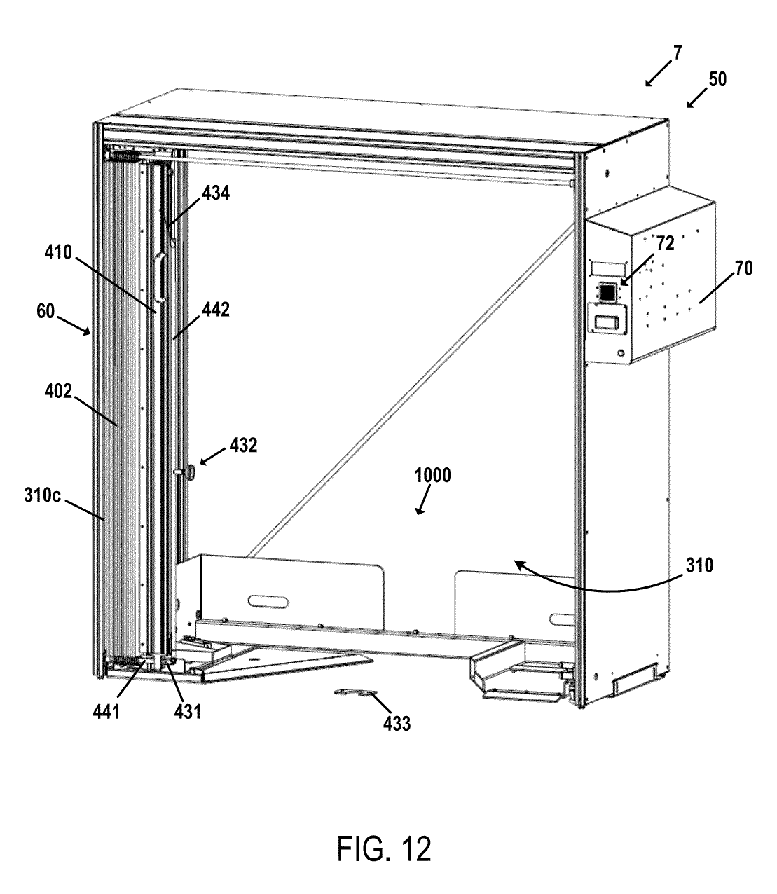

In various embodiments, the access door 60 is configured to slide laterally between an open position, in which the access door 60 permits access to items stored within the interior area of the housing 50 (e.g., items stored on shelves of a movable storage cart positioned within the housing), and a closed position, in which the access door 60 prevents access to items stored within the interior area of the housing 50. For example, FIG. 10 illustrates the dispenser 7 with the access door 60 in an open position, while FIG. 11 illustrates the dispenser 7 with the access door 60 in a closed position according to one embodiment. As discussed in greater detail below, the access door 60 also includes a movable security bar 430, which is adjustable between a retention position, in which the security bar 430 prevents a movable storage cart from being moved into or removed from the interior area of the housing 50, and an access position, in which the security bar 430 does not prevent the moveable storage cart form being moved into or removed from the interior area of the housing 50. For example, FIG. 12 shows the dispenser 7 with its security bar 430 in an access position, while FIGS. 10 and 11 shows the dispenser 7 with its security bar 430 in a retention position.

According to various embodiments, the dispenser's access door 60 is operatively connected to the housing 50 adjacent the housing's access opening 310 and generally comprises a flexible barrier 402 and a vertical support member 410. For example, the access door's flexible barrier 402 may comprise a fabric sheet made of the tear-resistant materials noted above in relation to the flexible barrier 202. Additionally, as shown in FIG. 11, the upper edge 402a of the flexible barrier 402 is operatively connected to the housing 50 by a first plurality of door attachment members comprising a first set of rings 403. As shown in FIG. 11, the first set of rings 403 is disposed along the flexible barrier's upper edge 402a and is engaged with an upper horizontal support member comprising an upper horizontal guide rod 420. According to various embodiments, the rings 403 and guide rod 420 may function in the manner described above in relation to the rings 203 and guide rod 120. The flexible barrier 402 is also attached along its side edges 402c, 402d to the vertical support member 410 and housing 50, respectively. According to various embodiments, the flexible barrier's side edges 402c, 402d are secured to the vertical support member 410 and housing 50 in the manner described above in relation to the flexible barrier 202, vertical support member 210, and housing 10 (e.g., using C-Shaped attachment members)

According to various embodiments, the access door's vertical support member 410 may comprise an elongated member formed of the high-strength materials noted above in relation to the vertical support member 210. In various embodiments, the vertical support member 410 is slidably connected to the housing 50 at its upper end by an upper sliding assembly configured to slide along an upper horizontal guide rail. For example, in certain embodiments, the upper sliding assembly and upper horizontal guide rail may comprise the components described above in relation to the upper sliding assembly 130 and the upper guide rail 125, and function in the manner described above in relation to the vertical support member 210, upper sliding assembly 130, and the upper guide rail 125. In this way, the vertical support member 410 is configured to slide laterally relative to the housing 50 in order to permit the access door 60 to move between its open and closed positions.

Various embodiments of the dispenser 7 also include an upper locking mechanism and open locking mechanism. Generally, the upper locking mechanism serves to selectively lock the access door 60 in its closed position, while the open locking mechanism serves to selectively lock the access door 60 in its open position. In certain embodiments, the upper locking assembly and open locking mechanism may comprise the components described above in relation to the upper locking mechanism 180 and the open locking mechanism 190, and function in the manner described above in relation to the upper locking mechanism 180 and the open locking mechanism 190.

According to various embodiments, the lower end of the vertical support member 410 includes a lower sliding assembly 460 configured to allow the vertical support member 410 to slide along a moveable security bar 430. As noted above, the security bar 430 is generally configured for movement between a retention position and an access position. The pivot joint 431 allows the security bar's moveable member 442 to be pivoted relative to the fixed member 441 between the aforementioned retention and access positions.

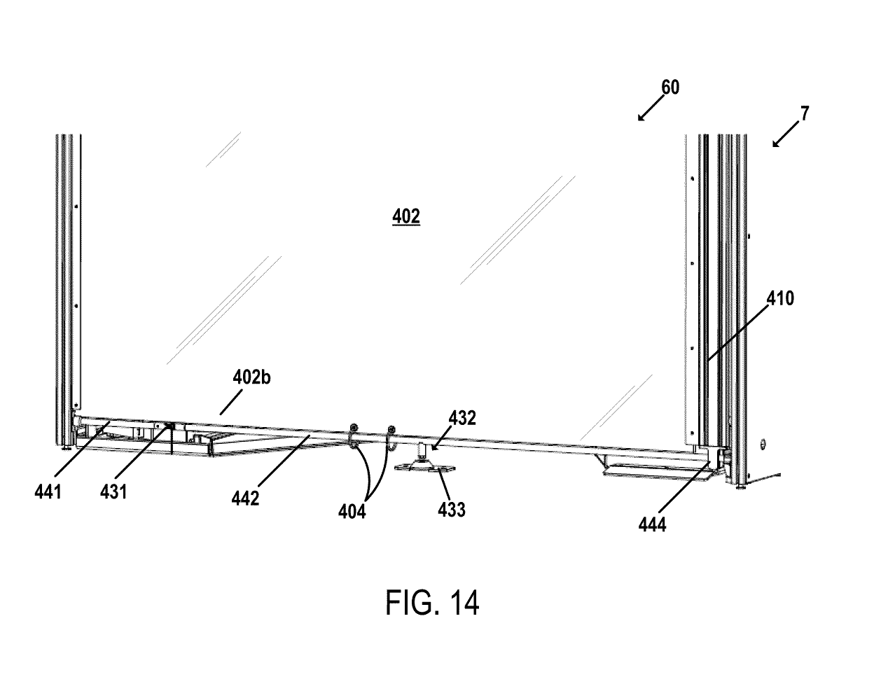

FIG. 14 shows a lower portion of the dispenser 7 with the security bar 430 moved to its retention position and the access door 60 closed. In the illustrated embodiment, the security bar 430 further comprises a support leg 432, which extends downwardly from a medial portion of the security bar's moveable member 442. The support leg 432 is generally configured to provide additional support for the security bar 430 to prevent it from being deformed when an external force is applied to the security bar 430 in the retention position (e.g., a generally vertical force applied to the security bar 430 in a downward direction toward the ground).

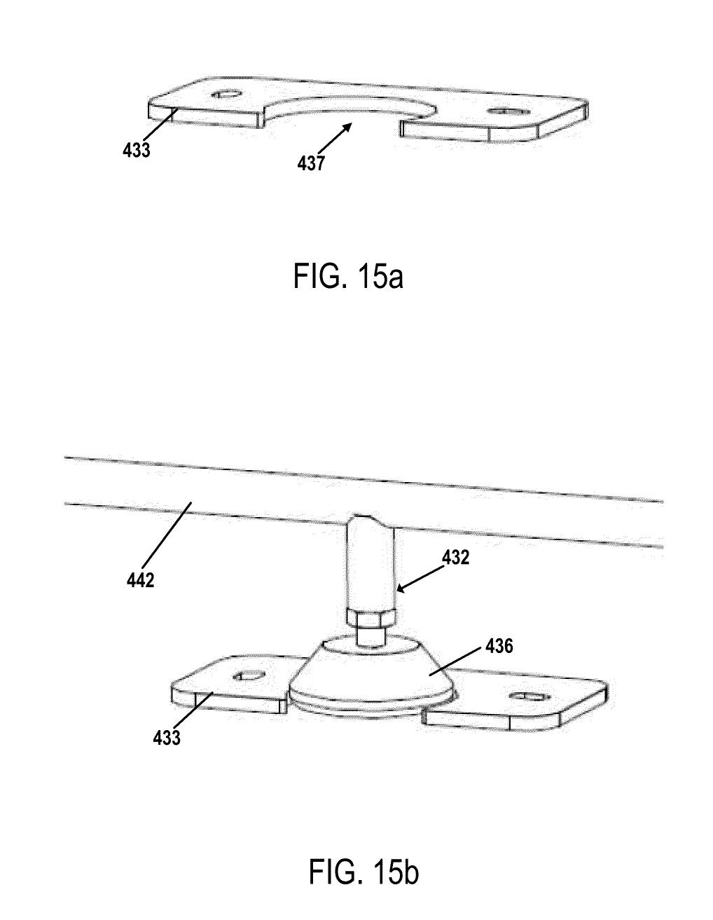

As shown in FIG. 14, the lower end of the support leg 432 is configured to engage a stopper 433 coupled to a support surface (e.g., a floor on which the dispenser 7 is positioned) beneath the support leg 432. The stopper 433 is generally configured to engage the support leg 432 and prevent the security bar 430 from being deformed toward the interior of the housing 50 when an inward force is applied to the security bar 430 in its retention position (e.g., a horizontal force applied to the security bar 430 in the direction of the housing's interior area). For example, FIG. 15a shows a detailed view of the stopper 433. In the illustrated embodiment, the stopper 433 comprises a thin plate secured to a support surface (e.g., with nails, an adhesive, or the like). As shown in FIG. 15a, the stopper 433 defines a recessed portion 437 dimensioned to receive a surface-engaging portion 436 of the support leg 432. In the illustrated embodiment, the recessed area 437 is crescent-shaped and configured to receive the support leg's circular surface-engaging portion 436, thereby preventing the support leg 432 and from sliding inward along the support surface. As an example, FIG. 15b shows a detailed view of the support leg 432 engaged with the stopper 433.

According to various embodiments, the components of the security bar 430 may be generally rigid and composed of a high-strength material, such as steel, aluminum, or high-strength composite or alloy materials. However, as will be appreciated from the description herein, the security bar 430 may be composed of any material of suitable strength and rigidity. In addition, various embodiments of the stopper 433 may comprise any member or feature that prevents the security bar 430 from being pushed into the interior area of the housing 50. For example, various embodiments of the stopper may comprise a hole, indentation, clasp, block, or any other restraining device located in or coupled to the surface beneath the support leg 432.

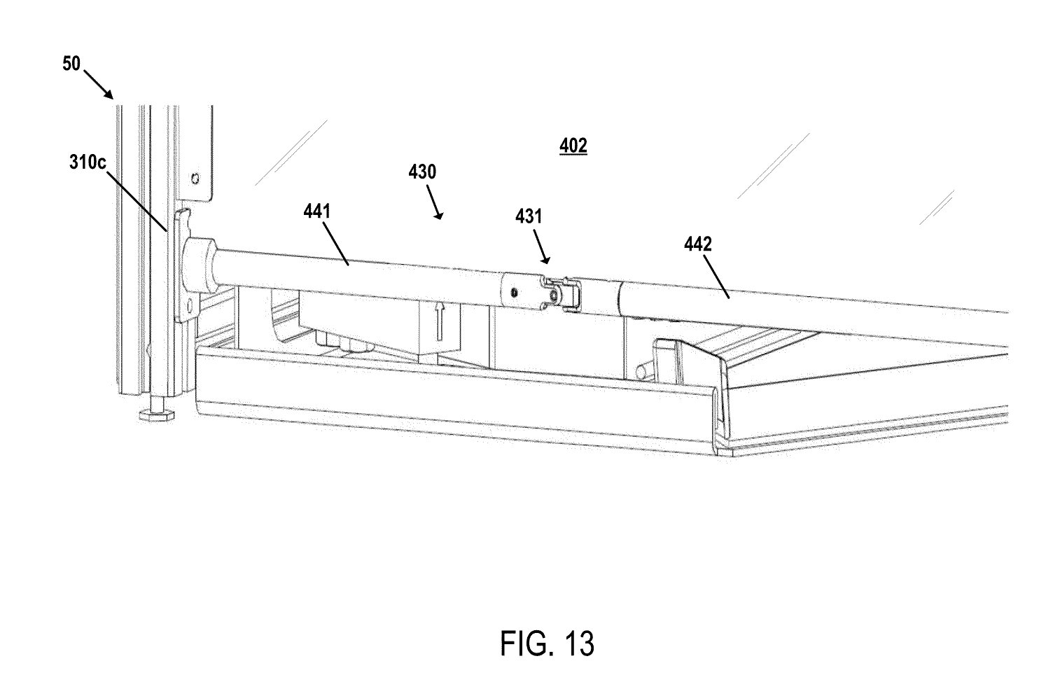

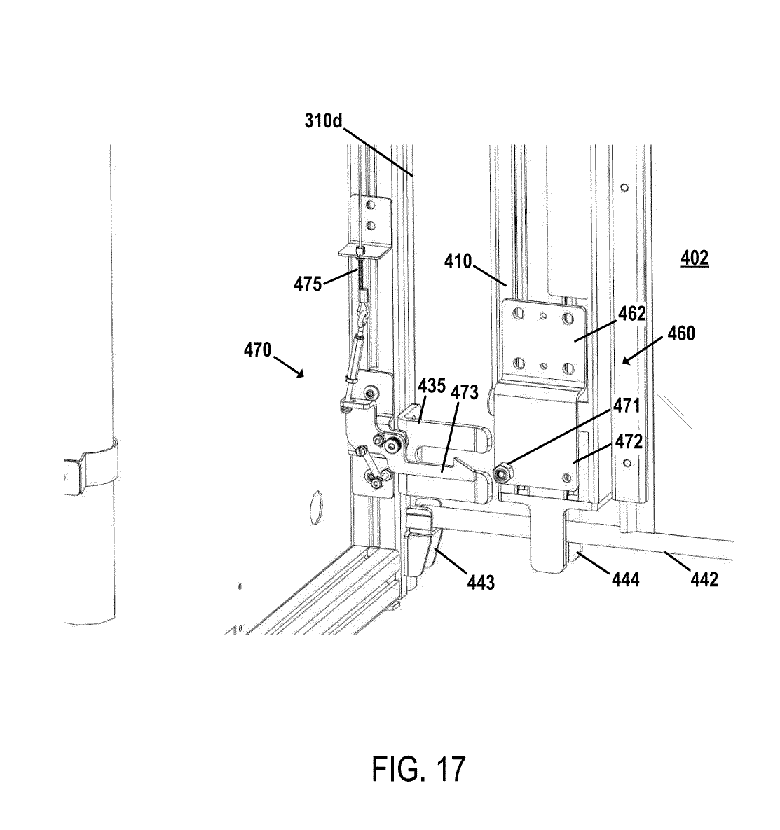

As noted above, the lower end of the vertical support member 410 includes a lower sliding assembly 460 configured to allow the vertical support member 410 to slide along the security bar 430. According to various embodiments, the vertical support member's lower sliding assembly includes a guide member 444. As can be appreciated from FIGS. 10-14, the guide member 444 is configured to guide the lower portion of the vertical support member 410 laterally along the security bar 430 as the access door 60 is moved between its open and closed positions. FIG. 17 shows a lower portion of the vertical support member 410 as the access door 60 is approaching the access opening's second lateral side 310d viewed from the interior area of the housing 50 according to one embodiment. In the illustrated embodiment of FIG. 17, the guide member 444 comprises an inverted u-shaped member dimensioned to fit around the security bar 430 and enable the vertical support member 410 to slide relative to the security bar 430. In various embodiments, the guide member 444 may be formed from a low-friction, bearing-grade plastic (e.g., acetal). As can be appreciated from FIG. 17, the guide member 444 ensures the lower portion of the vertical support member 410 is aligned with the security bar 430 as it slides laterally between the access door's open and closed positions.

Turning back to FIG. 14, the lower edge 402b of the flexible barrier 402 is operatively connected to the security bar 430 by a second plurality of door attachment members comprising a second set of rings 404. As shown in FIG. 14, the second set of rings 404 are disposed along the flexible barrier's lower edge 402b and engaged with the lower security bar 430. In certain embodiments, the rings 404 may be disposed along the flexible barrier's lower edge 402b such that their movement is not interrupted by the support leg 432 as the vertical support 410 is moved towards the access opening's first lateral side 310c. For example, as shown in FIG. 14, the rings 404 are disposed along a portion of the flexible barrier's lower edge 402b that corresponds with the portion of the security bar 430 between the support leg 432 and the access opening's first lateral side 310c. According to various embodiments, the rings 404 and lower security bar 430 function in the manner described above in relation to the rings 203 and guide rod 120. Accordingly, as shown in FIGS. 10 and 11, the rings 403 and 404, the upper horizontal guide rod 420, and the lower security bar 430 secure the flexible barrier 402 to the housing 50 such that the flexible barrier 402 extends substantially across the height of the access opening 310 and is laterally movable between the aforementioned open and closed positions.

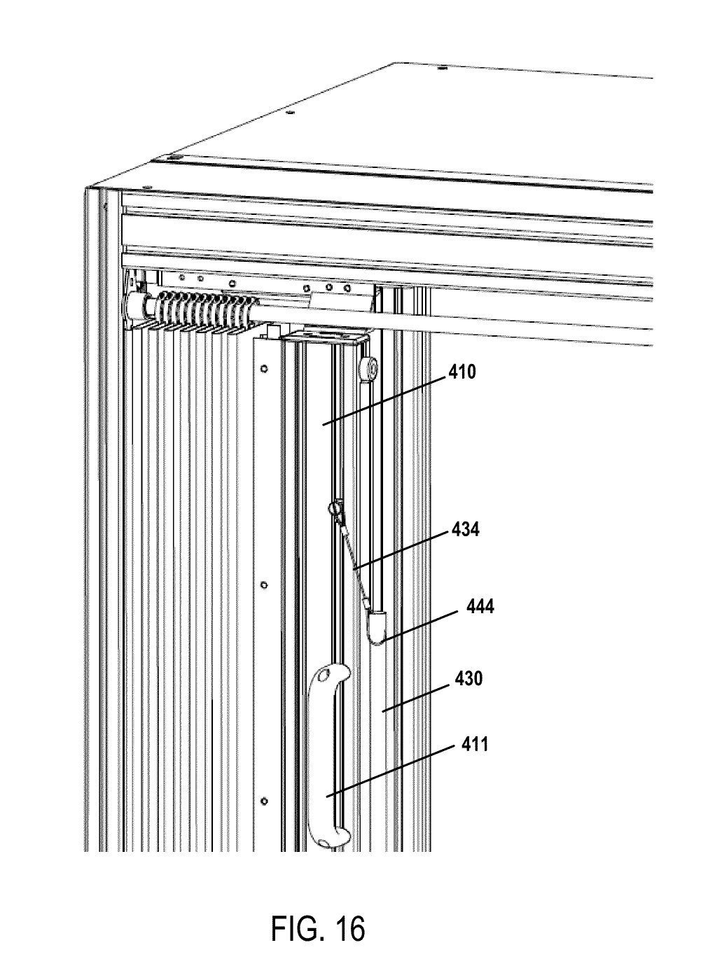

As noted above, the security bar 430 is generally configured for movement between a retention position and an access position. For example, FIG. 10 illustrates the dispenser 7 with the access door 60 in its open position and the security bar 430 in its retention position. With the access door 60 in its open position (e.g., such that the vertical support member 410 is positioned adjacent the access opening's first lateral side 310c, past the pivot joint 431, and secured in this position by the open locking mechanism), the security bar's moveable member 442 is free to be pivoted upwardly via the pivot joint 431 (e.g., by being manually lifted and pivoted by a user) to the access position, which is shown in FIG. 12. To secure the security bar 430 in this access position, the vertical support member 410 includes a fastener in the form of a retaining leash 434 configured to engage the security bar's moveable member 442 and hold it upward in the access position. As an example, FIG. 16 provides a detailed view of an upper portion of the vertical support member 410 with the security bar 430 secured in its access position. As shown in FIG. 16, the retaining leash 434 is connected to the vertical support member 410 at one end (e.g., a bolt or screw) and defines a looped portion 444 at its opposite end, which is configured to be positioned around the end of the security bar's moveable member 442 in order to hold the moveable member 442 in its upwardly-pivoted access position.

As will be appreciated from FIG. 12, with the lower security bar 430 in its access position and the access door 60 in its open position, the security bar 430 and access door 60 do not obstruct the dispenser's access opening 310 and user access to the interior area of the housing 50 is permitted. In particular, with the access door 60 in the open position, the flexible barrier 402 is compressed into a plurality of folds and does not obstruct access to the interior area of the housing 50 through the access opening 310. As such, a user is free to remove items or replace items stored within the dispenser 7 (e.g., on a moveable storage cart). With the security bar 430 also moved to its access position, a moveable storage cart can be moved into or out of the dispenser 7. As explained in greater detail herein, in certain embodiments, this can be accomplished with the aid of the dispenser's cart guide apparatus 1000.

To readjust the access door 60 to its closed position, the security bar 430 can first be lowered back to its retention position (e.g., as shown in FIG. 10) by pivoting the moveable member 442 downward via the pivot joint 431. With the moveable member 442 in its retention position, the vertical support member 410 can then be disengaged from the open locking mechanism and slid laterally to the access opening's second lateral side 310d (e.g., as shown in FIG. 11). For example, FIG. 17 shows a lower portion of the vertical support member 410 as the access door 60 is approaching the access opening's second lateral side 310d viewed from the interior area of the housing 50 according to one embodiment. As shown in FIG. 17, when the moveable member 442 is pivoted downward to its retention position, the end of the moveable member 442 is received by a support member 443 comprising a u-shaped bracket secured to the second lateral side 310d of the dispenser's access opening. In combination with the support leg 432, the support member 443 is configured to support the security bar 430 in its retention position and prevent it from be deformed during an attempted theft from the dispenser 7. In this way, the security bar 430 also functions to prevent tampering with the lower portion of the flexible barrier 402.

In addition to the aforementioned upper locking mechanism, the dispenser 7 also includes a lower locking mechanism configured to selectively engage the vertical support member 410 in order to further secure the access door 60 in this closed position. As shown in FIG. 17, the lower locking mechanism 470 is secured to an interior area of the housing 50 adjacent a lower portion of the access opening's second lateral side 310d. In the illustrated embodiment, the lower locking mechanism 470 includes a latch 473, which is pivotably connected to the housing 50, and a wire 475, which connects the latch 473 to a lower latch release component in the upper locking mechanism (e.g., a release component as discussed above in relation to the upper locking mechanism 180).

In addition, various embodiments of dispenser's lower locking mechanism include a shielding assembly configured to prevent applied external forces from interfering with the mechanism's locking function. As shown in FIG. 17, the shielding assembly comprises a security flange 435 coupled to the dispenser's access opening 310 at the second lateral side 310d. In the illustrated embodiment, the security flange 435 is a rigid, forked member defining a central recessed area.

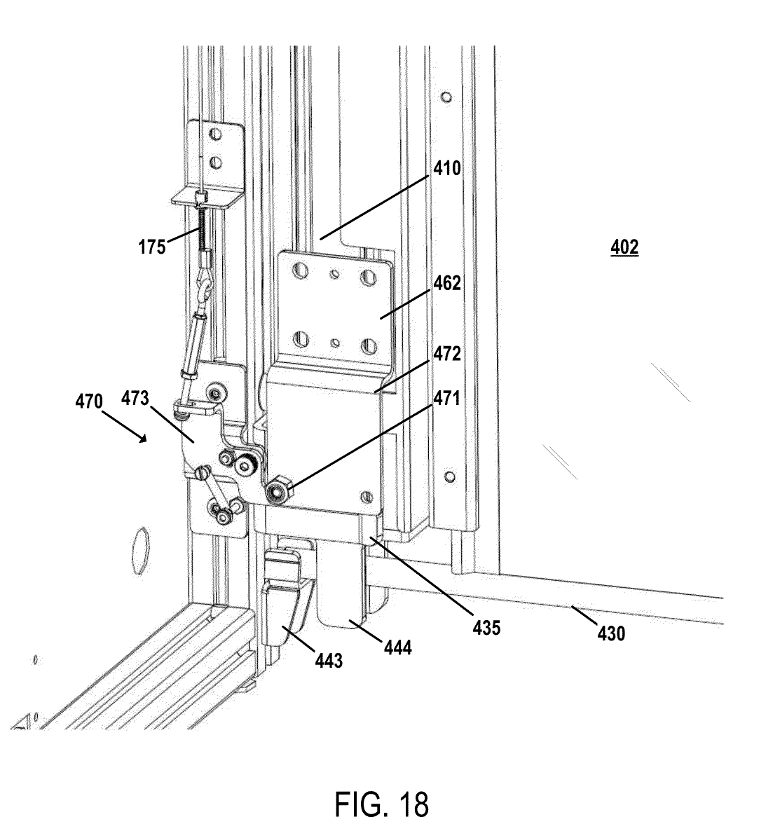

As shown in FIG. 17, the lower portion of the vertical support member 410 is operatively connected to its lower sliding assembly 460 by a lower bracket 462 and includes a protector plate 472, which extends first inwardly and then downwardly from the lower bracket 462. In addition to the aforementioned guide member 444 and the protector plate 472, the lower sliding assembly 460 also includes a lower locking bolt 471, which is supported horizontally by a lower portion of the protector plate 472. As can be appreciated from FIGS. 17 and 18, the latch 473 is configured to engage the lower locking bolt 471 supported by the lower sliding assembly's protector plate 472. In particular, the lower locking mechanism 470 is configured such that, when the access door 60 is moved to its fully closed position as shown in FIG. 18, the lower locking mechanism's latch 473 engages the lower locking bolt 471 and prevents the access door 60 from being moved out of its closed position. In this way, the lower locking bolt 471 functions as a locking member for engaging the lower locking mechanism 470.

As shown in FIG. 18, when the access door 60 is in the fully closed position, the security flange 435 is configured to fit between the vertical support member 410 and the protector plate 472. As such, the security flange 435 will engage either the vertical support member 410 or the protector plate 472 if an external force is applied to the access door 60 or vertical support member 410, thereby providing an additional level of security for preventing access to the interior area of the housing 50. The security flange 435 also serves to shield the latch 473 from being tampered with and unlocked by an unauthorized user. The security flange 435 also serves to prevent inadvertent contact with the latch 473 (e.g., by a storage cart being inserted into the dispenser). Similarly, the protector plate 472 serves to shield from the latch 473 from being inadvertently damaged or deliberately tampered with.

As will be appreciated from FIGS. 11, 14, and 18, with the access door 60 locked in its closed position, the access door 60 functions to prevent access to items stored within the interior area of the housing 50. Moreover, in the illustrated embodiment, the access door 60 is unable to be moved to its closed position without the security bar 430 being adjusted to its retention position. This ensures that, when the access door 60 is in its closed position, the security bar 430 is necessarily in its retention position and enhances the theft-prevention capability of the dispenser 7.

According to various embodiments, the dispenser 7 also includes a control system 70 having a user interface 72. To restrict access to authorized users only, the control system 70 is generally configured to control the locking mechanisms to lock and unlock the access door 60 based on input received from a user. The control system 70 and user interface 72 may be configured, for example, to operate in substantially the same manner as the control system 30 and user interface 32 described above. Additionally, the dispenser 7 may also include a biasing system configured to bias the access door 20 to the closed position of FIGS. 11 and 18 (e.g., a biasing system similar to the biasing system described herein in relation to the dispenser 5). According to certain embodiments, the dispenser's upper and locking mechanisms may be configured such that the vertical support member's lower locking bolt 471 will engage the lower locking mechanism 470 before the upper locking mechanism engages (or vice versa).

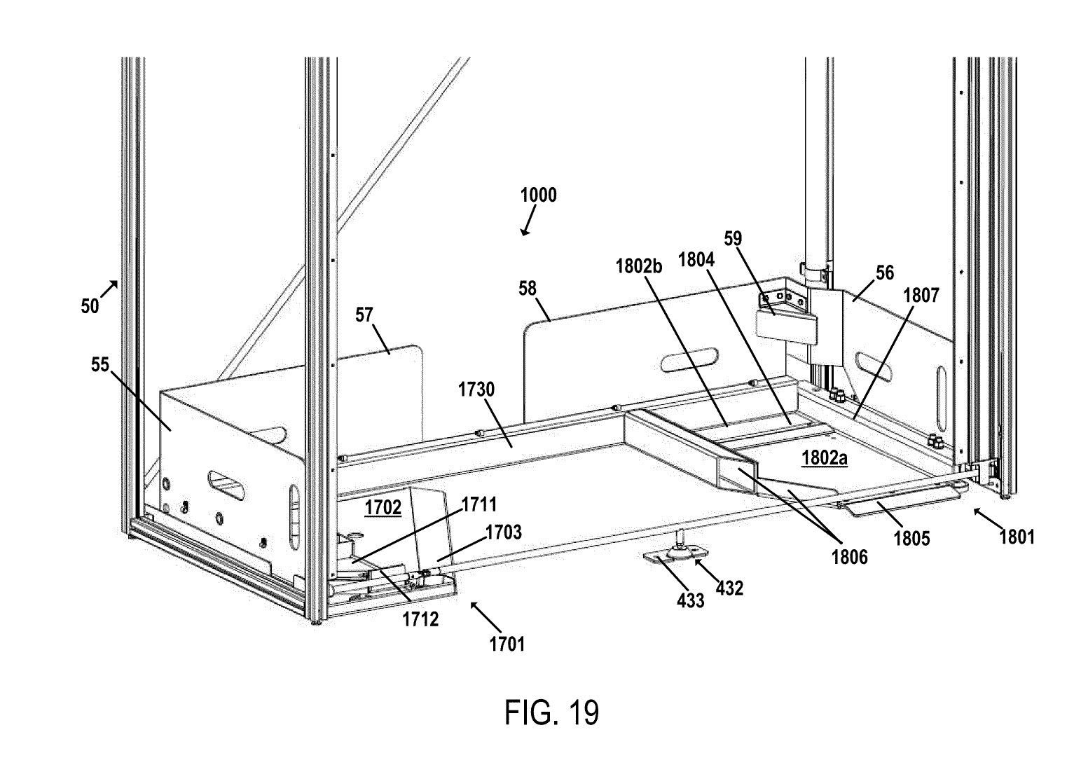

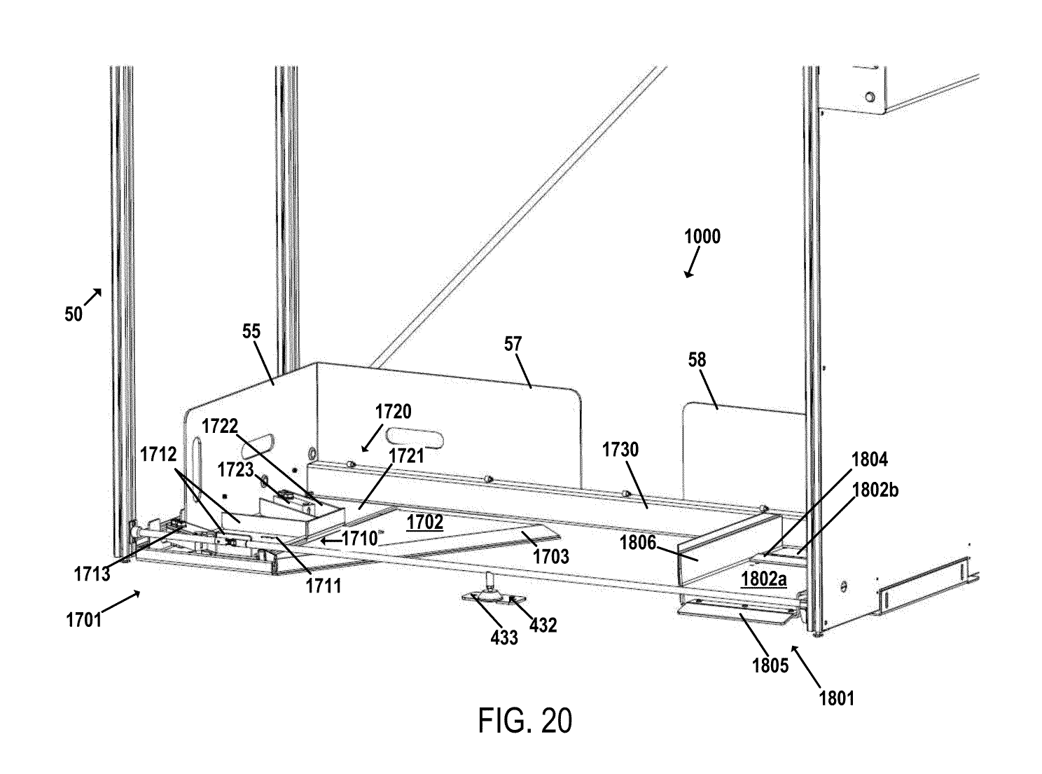

As noted above, various embodiments of the dispenser 7 include a cart guide apparatus 1000 located adjacent a lower perimeter of the interior area of the housing 50, configured to guide a movable storage cart 200 into the interior area of the housing 50 through the housing's access opening 310 and to secure the movable cart 200 in the interior area of the housing 50. For example, FIGS. 19 and 20 provide detailed perspective views of the dispenser's cart guide apparatus 1000 according to one embodiment. In particular, FIGS. 19 and 20 show the dispenser 7 with the access door 60 and certain of the housing panels 302, 304 removed.

As shown in FIGS. 19 and 20, the guide apparatus 1000 includes a wheel support comprising a front wheel support 1701 spaced apart from a rear wheel support 1801. According to various embodiments, the wheel supports 1701, 1801 are generally configured for supporting the wheels of a storage cart (e.g., a storage cart with a pair of front, fixed wheels and a pair of rear, pivoting wheels). As can be appreciated from FIGS. 19 and 20, the front and rear wheel supports 1701, 1801 are operatively connected to one another by a connecting wall 1730.

The front wheel support 1701 defines an entrance floor 1702 and a front wheel ramp 1703. As described in greater detail herein, the front wheels of the storage cart may be moved over the front when ramp 1703 and onto the entrance floor 1702 before they are maneuvered into their respective enclosures. As shown in FIGS. 19 and 20, the front wheel support 1701 further comprises a first front wheel enclosure 1710 and a second front wheel enclosure 1720. The first front wheel enclosure 1710 is defined by a first plurality of vertical walls 1712 extending vertically upward from a first floor portion 1711, while the second front wheel enclosure 1720 is defined by a second plurality of vertical walls 1722 extending vertically upward from a second floor portion 1721 (e.g., such that the floor portions 1711, 1721 define an area separate from the entrance floor 1702). The first and second plurality of vertical walls 1712, 1722 are generally configured to separate the first and second front wheel enclosures 1710, 1720 from other components of the wheel support.

As shown in FIG. 19, the wheel support also includes a rear wheel support 1801. The rear wheel support 1801 comprises a rear wheel enclosure 1802 that includes a first floor portion 1802a and a second floor portion 1802b separated by a rear wheel lock 1804. In the illustrated embodiment, the rear wheel lock 1804 comprises a ridge positioned between first floor portion 1802a and a second floor portion 1802b (e.g., a ridge of sufficient height and size to prevent a cart wheel from inadvertently rolling across the rear wheel lock 1804 during normal operation). The rear wheel enclosure 1802 is further defined by a plurality of rear vertical walls 1806 configured to separate the rear wheel support 1801 from other components of the wheel support. The rear wheel support 1801 also includes a rear wheel ramp 1805 leading to the first floor portion 1802a.

In certain embodiments, the first and second front wheel enclosures 1710, 1720 are each supported by one or more load cells 1713, 1723, respectively. Similarly, the rear wheel support 1801 may be supported by one or more rear load cells 1807 configured to work with the load cells 1713, 1723 to weigh a storage cart positioned within the housing 50 and on the wheel support. For example, in certain embodiments, the load cells 1713, 1723, 1807 may be configured to determine an aggregated weight of all items present on a storage cart disposed within the housing 50 (e.g., by weighing the cart and its contents and subtracting a predefined cart weight). In various combinations, the load cells 1713, 1723, 1807 may be in communication with the control system 70, and the control system 70 may be connected to a remote server over a network that is configured to monitor the amount of items present in one or more dispensers connected over the network. Similar to the control system 30 described above, the control system 70 may be adapted for use in an inventory management system such as that disclosed in U.S. application Ser. No. 11/236,214, now U.S. Pat. No. 7,428,447, the entirety of which is herein incorporated by reference.

The guide apparatus 1000 also includes a plurality of guide walls configured for guiding a moveable storage cart to a desired position within the dispenser's housing 50. In the illustrated embodiment, the guide apparatus 1000 includes a first lateral guide wall 55 extending upwardly from the front wheel support 1701, a second lateral guide wall 56 extending upwardly from the rear wheel support 1801, a first rear guide wall 57 extending upwardly from a first side of the connecting wall 1730, and a second rear guide wall 58 extending upwardly from a second side of the connecting wall 1730. As can be appreciated from FIGS. 19 and 20, each of the guide walls 55-58 is oriented vertically and positioned in a lower portion of the dispenser's housing 50. In particular, the lateral guide walls 55, 56 are positioned within the housing 50 adjacent to and spaced from the housing's lateral walls, while the rear guide walls 57, 58 are positioned within the housing 50 adjacent to and spaced from the rear wall.

In various embodiments, the guide apparatus 1000 may also include one or more intermediate or auxiliary guide walls. For example, in the illustrated embodiment of FIG. 19, the guide apparatus 1000 includes an auxiliary guide wall 59, which extends between medial portions of the second rear guide wall 58 and the second lateral guide wall 56. In various embodiments, the guide walls 55-59 are generally rigid and composed of a high-strength material, such as steel, aluminum, or high-strength composite or alloy materials. However, as will be appreciated from the description herein, the guide walls 55-59 may be composed of various materials of suitable strength and rigidity.

According to various embodiments, the guide walls 55-59 are configured to engage the body portion 201 of a storage cart 200 as it is being moved into the housing 50 and thereby guide the storage cart 200 into the housing 50. In particular, the guide walls 55-59 are positioned such that, as the storage cart 200 is being moved into the housing 50, the guide walls 55-59 prevent the storage cart 200 from contacting the housing's walls (e.g., the panels 302-304 and rear cross bar 306). In some embodiments, the guide walls 55-59 are coupled to the wheel support such that each of the guide walls 55-59 is positioned within the interior of the dispenser 7 and some distance away from the walls of the housing 50. In various embodiments, the plurality of guide walls 55-59 may be positioned such that a cart 200 being moved into the interior area of the housing 50 is guided such that the cart wheels 221-224 are supported by the load cells 1713, 1723, 1807. Specifically, the auxiliary guide wall 59 (which may be included or omitted from various embodiments of the dispenser) may be positioned such that a cart 200 being moved into the interior area of the housing 50 that contacts the auxiliary guide wall 59 is guided to such a position that the cart wheels 221-224 are supported by the load cells 1713, 1723, 1807 when the cart is in the loaded position. Additionally, the auxiliary guide wall 59 may be positioned to guide the cart 200 some distance away from the second lateral guide wall 56 in order to facilitate removal of the cart 200. In various embodiments, the dispenser may include one or more auxiliary guide walls 59 of different sizes and located at different positions to accommodate storage carts of different sizes within the dispenser's housing. Likewise, certain embodiments of the dispenser may not include an auxiliary guide wall 59 when configured for use with carts that fit properly within the dispenser without the need to be guided by the auxiliary guide wall.

By preventing the storage cart 200 from contacting the housing's walls, the guide walls 55-59 enable the housing's walls to be constructed from materials that need not be capable of withstanding repeated collisions by a storage cart 200 moved into the housing 50. In addition, various embodiments of the guide walls 55-59 are configured to guide the storage cart 200 into the housing 50 such that the wheels 221-224 of the storage cart are not required to be directly engaged by the various components of the guide apparatus 1000. By reducing or eliminating contact with the wheels 221-224 of the storage cart 200, damage to the wheels 221-224 of the storage cart 200 can be reduced and reliability of the storage cart and dispenser can be improved.

As will be appreciated from the description provided herein, various modifications to the dispenser 7 may be made within the scope of the present invention. For example, the various components of the guide apparatus 1000 may be dimensioned for use with storage carts of various shapes and sizes. In addition, the guide walls 55-59 of the guide apparatus 1000 may be separate guide walls, a single continuous wall, integrated portions of the wheel support, or separate components of the guide apparatus. In certain embodiments, the guide walls 55-59 may not be spaced from the housing walls, but nevertheless configured to shield the housing walls from contact with the cart body 201. For example, the guide walls 55-59 may be disposed directly on housing walls or disposed on housing walls with impact absorbing material, such as foam, positioned therebetween. Furthermore, various embodiments of the dispenser's security bar 430 may be configured to extend across at least a portion of the dispenser's access opening from various locations on the dispenser 7 and may be provided in various shapes and sizes. Likewise, various modifications to the dispenser 7 analogous to those discussed above in relation to the dispenser 5 are also contemplated.

Exemplary Positioning of a Cart within a Dispenser

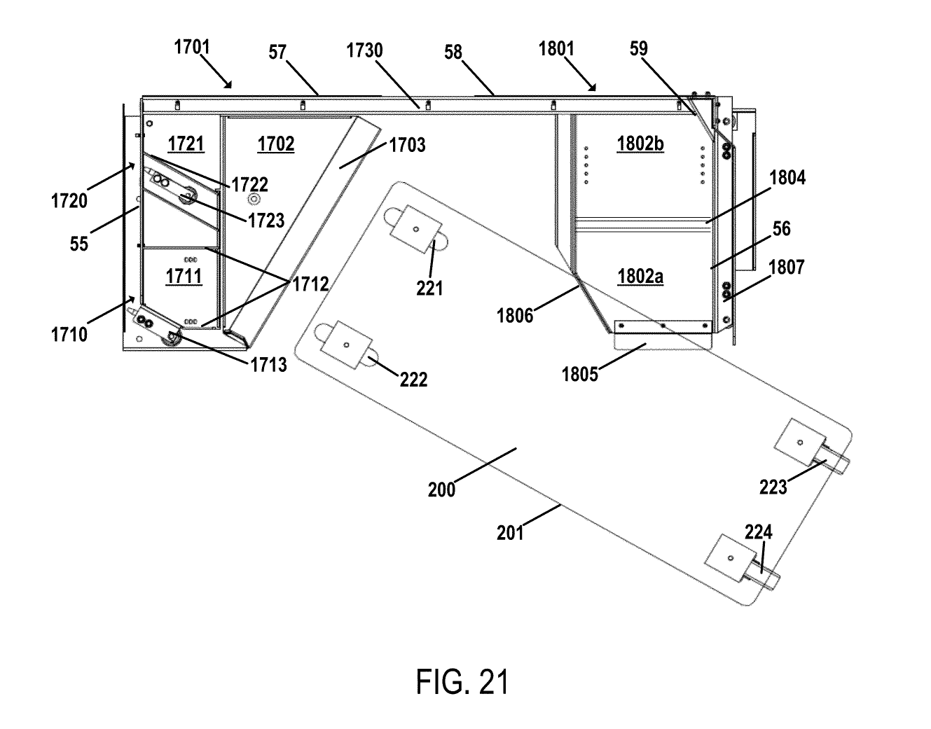

FIGS. 21-25 illustrate an example of the general operation of the dispenser's guide apparatus 1000 and a method for inserting a moveable storage cart into the dispenser 7. In particular, the illustrated example shows steps for inserting a movable storage cart 200 into the housing 50 of the dispenser 7. As shown in FIG. 21, the storage cart 200 includes two substantially fixed (e.g., non-swiveling) front wheels 221, 222, and two swiveling rear wheels 224, 223. However, it should be understood that similar techniques may be used in conjunction with carts having other combinations and types of wheels (e.g., two front swiveling wheels and two rear swiveling wheels).

Beginning with the illustration of FIG. 21, the dispenser 7 is first configured by a user such that the access door 60 is moved to its open position and the security bar 230 is moved to its access position. The user next positions the cart 200 as shown in FIG. 21 so that the cart's fixed, front wheels 221, 222 are substantially aligned with the front wheel ramp 1703 and the cart 200 is approaching the interior area of the dispenser's housing 50 at an angle relative to the access opening 310. As shown in FIG. 21, when aligned prior to insertion of the cart 200 into the dispenser 7, the cart 200 may be oriented such that the longitudinal axis of the cart 200 is at an angle between about 10 and 80 degrees with respect to a plane defined by the housing's access opening 310. When oriented prior to insertion into the dispenser 7, the cart 200 may be positioned such that at least part of the front portion 215 of the storage cart 200 may be located within the interior area of the housing 50. In particular, at least a first front corner, defined as the location where the front side 225 and first lateral side 227 of the cart body 201 meet, may be located within the interior area of the housing 50.

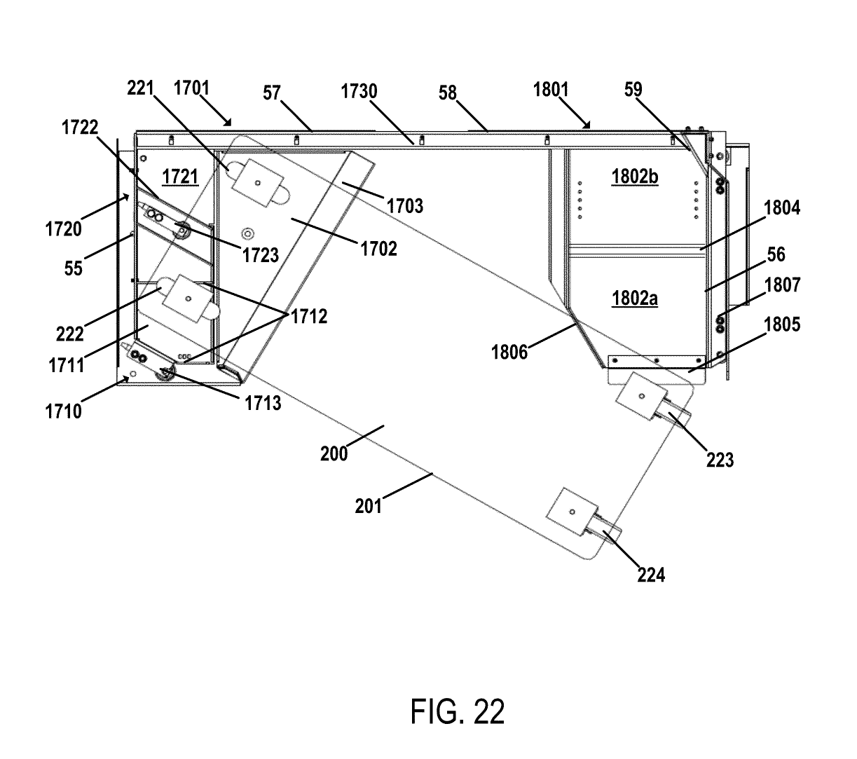

As shown in FIG. 22, the user next pushes the cart 200 such that its fixed, front wheels 221, 222 travel onto the front wheel ramp 1703 and continue until the front portion 215 of the cart body 201 engages at least one of the plurality of guide walls 55-59. Specifically, the first front corner of the cart body 201 may engage the second rear guide wall 58, and a second front corner of the cart body 201, defined as the location where the front side 225 and second lateral side 228 of the cart body 201 meet, may engage the second lateral guide wall 56. In this position, the second fixed, front wheel 222 is at least partially within the first front wheel enclosure 1710, and the first fixed, front wheel 221 is on the entrance floor 1702. In certain instances, a portion of the first fixed, front wheel 221 may be at least partially within the second front wheel enclosure 1720 (e.g., depending on the size and orientation of the cart and its wheels, and the exact angle at which the cart 200 was inserted). Moreover, in this position, at least part of the rear portion 216 of the cart body 201 may remain outside the housing 50, and the cart's first rear wheel 223 may be located substantially adjacent to the rear wheel ramp 1805. Depending on the orientation at which the cart 200 is inserted, in various embodiments a portion of the first rear wheel 223 may be located on or above a portion of the rear wheel ramp 1805.

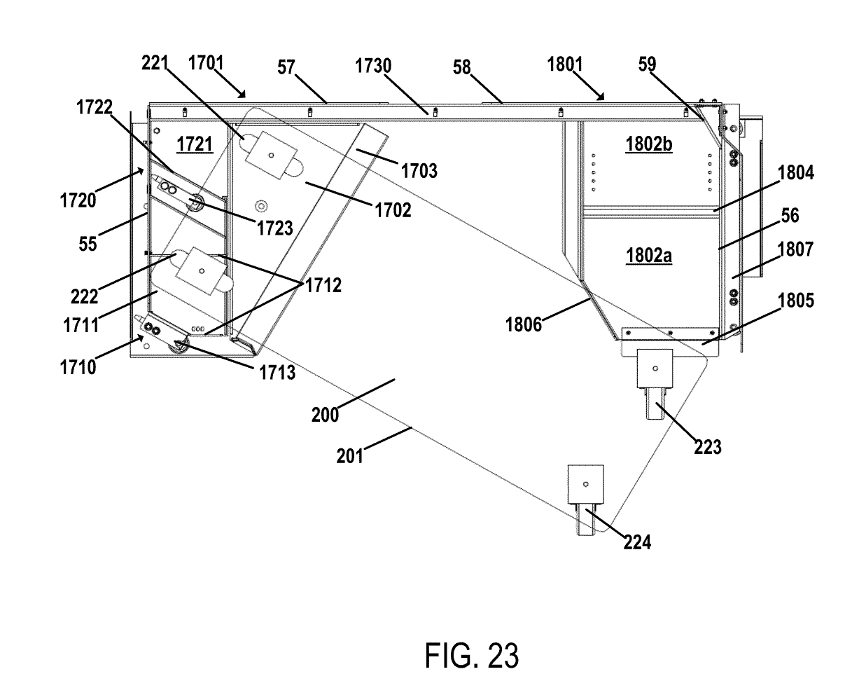

Next, the user pushes the rear portion 216 of the cart body 201 toward the rear wheel support 1801. As shown in FIG. 23, this causes the cart's swiveling, rear wheels 223, 224 to rotate from (1) a first orientation in which the cart's rear wheels 223, 224 are substantially parallel to the cart's front wheels 221, 222 (e.g., as shown in FIG. 22) to (2) a second orientation in which the cart's rear wheels 223, 224 are oriented to travel toward the rear wheel support's rear wheel ramp 1805 and onto the first floor portion 1802a of the rear wheel enclosure 1802 (e.g., as shown in FIG. 23).

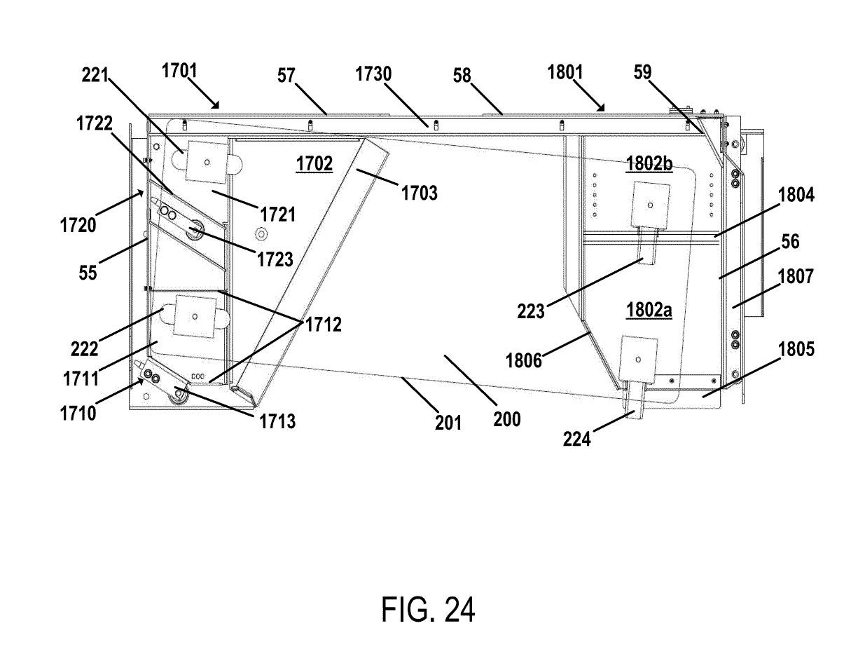

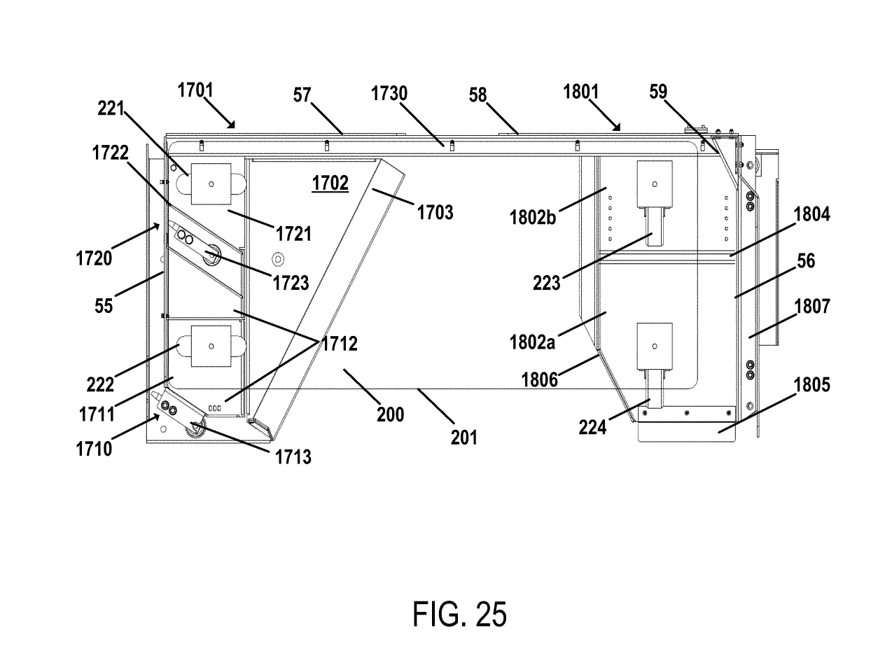

Next, the user pushes the rear portion 216 of the cart body 201 such that cart body 201 rotates into the dispenser's housing 50 and is guided by the cart guide's guide walls 55-59 such that the cart 200 generally pivots about a vertical axis extending through the cart's second fixed front wheel 222. In particular, as the user pushes the rear portion 216 of the cart body 201, the first swiveling rear wheel 223 rolls over the rear wheel ramp 1805, onto the first floor portion 1802a of the rear wheel enclosure 1802, and engages the rear wheel lock 1804. This position is shown in FIG. 24. Next, the user continues pushing the rear portion 216 of the cart body 201 into the housing 50 until at least a portion of the cart body 201 contacts the second rear guide wall 58 as shown in FIG. 25. This causes (1) the cart's first rear wheel 223 to move over the rear wheel lock 1804 and onto the second floor portion 1802b of the rear wheel enclosure 1802, (2) the cart's second rear wheel 224 to move over the rear wheel ramp 1805 and onto the first floor portion 1802a of the rear wheel enclosure 1802, (3) the first front corner of the cart body 201 to move substantially parallel to the second rear guide wall 58, and toward the second lateral guide wall 56, (4) the second front corner of the cart body 201 to move substantially parallel to the second lateral guide wall 56 and toward the access opening 310 of the housing 50, and (5) the first front wheel 221 to move into the second front wheel enclosure 1721. In various embodiments, a first rear corner of the cart body, defined as the location where the rear side 226 and first lateral side 227 of the cart meet, may contact the auxiliary guide wall 59 while the rear portion 216 of the cart body 201 is guided into the interior area of the housing 50. As will be understood from FIGS. 24-25, the first rear corner of the cart body 201 may slide along a face of the auxiliary guide wall 59, thus guiding the cart body 201 towards the first lateral guide wall 55 as the rear portion 216 of the cart body 201 moves towards the second rear guide wall 58. As shown in FIG. 25, the auxiliary guide wall 59 may be positioned to prevent the cart 200 from moving parallel to the rear guide walls 57, 58 toward the second lateral guide wall 56 when the cart 200 is in the loaded position.

In the resulting loaded position shown in FIG. 25, the cart 200 is fully inserted within the interior area of the dispenser's housing 50 and supported by the cart guide apparatus 1000. In the loaded position, the front side 225 of the cart body 201 may be located substantially adjacent and parallel to the second lateral guide wall 56, the rear side 226 of the cart body 201 is located substantially adjacent and parallel to the first lateral guide wall 55, and the first lateral side 227 of the cart body 201 is located substantially adjacent and parallel to the first and second rear guide walls 57, 58. As a result, the access door 60 can be moved to its closed position and the security bar 230 moved to its retention position in order to resume normal use of the dispenser 7. Additionally, in the loaded position shown in FIG. 25, the cart 200 is supported by the cart guide apparatus 1000 such that its weight can be detected by the load cells 1713, 1723, 1807 and transmitted as data via the control system 70. As noted above, moving the rear of the cart 200 into the dispenser 7 also causes the first rear wheel 223 to roll beyond the rear wheel lock 1804 which prevents the cart 200 from inadvertently rolling out of the dispenser 7 during use. In other words, the cart 200 can only be removed from the dispenser's housing 50 by a user deliberately pulling the cart 200 over the rear wheel lock 1804 (e.g., by a user who is authorized to have access to the dispenser 7 and is able to adjust the access door 60 and security bar 230).

To remove a cart 200 from the dispenser, the user may follow an analogous procedure. For example, the user may first guide the rear portion 216 of the cart 200 out of the dispenser 7 (e.g., as effectively shown in FIG. 24). The user continues guiding the rear of the cart 200 out of the dispenser until the first rear corner of the cart body 201 is located outside of the interior area of the housing 50, and on the exterior side of the access opening 310. The user then guides the front portion 215 of the cart 200 out of the dispenser 7, which causes (1) the rear wheels 223, 224 to rotate from the aforementioned second orientation to the aforementioned first orientation and (2) the cart's front wheels 221, 222 to move off the front wheel ramp 1703.

As will be appreciated from the above description, the aforementioned procedure for inserting the cart 200 into the dispenser 7 enables a user to position the cart 200 by engaging its body 201 with the cart guide's various guide walls 55-59. Using this method, it is not necessary to engage the cart's wheels 221-224 with the walls defining the wheel enclosures 1710, 1720, 1802 and the cart 200 can be guided into the appropriate position within the dispenser 7 without engaging the panels defining the housing 50.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A dispenser for storing a moveable cart having a plurality of wheels and a cart body configured for storing one or more items, the dispenser comprising:
a housing comprising one or more housing walls defining an access opening and an interior area dimensioned for receiving the moveable cart;
an access door disposed adjacent the access opening, the access door configured for movement between (i) a closed position in which the access door prevents access to the cart when the cart is stored within the interior area of the housing and (ii) an open position in which the access door permits access to the cart when stored within the interior area of the housing; and
a cart guide apparatus positioned substantially within the housing, the cart guide apparatus comprising one or more guide walls configured to engage the cart body and guide the moveable cart to a loaded position within the interior area of the housing, wherein the one or more guide walls permit a user to move the moveable cart into the interior area of the housing without engaging the one or more housing walls.

2. The dispenser of claim 1, wherein the one or more guide walls are disposed adjacent a lower perimeter of the housing's interior area.

3. The dispenser of claim 2, wherein the one or more guide walls comprise one or more substantially vertical wall members.

4. The dispenser of claim 1, wherein the one or more guide walls are spaced from the one or more housing walls in a direction toward the housing's interior area.

5. The dispenser of claim 1, wherein the one or more guide walls are configured to engage a front portion of the cart body during insertion of the front portion of the cart body into the interior area of the housing and engage a rear portion of the cart body during insertion of the rear portion of the cart body into the interior area of the housing.

6. The dispenser of claim 5, wherein the one or more guide walls comprise a first lateral guide wall disposed adjacent a first lateral side of the housing's interior area and a first rear guide wall disposed adjacent a rear portion of the housing's interior area, wherein the first lateral guide wall and first rear guide wall are configured to engage the front portion of the cart body during insertion of the front portion of the cart body into the interior area of the housing.

7. The dispenser of claim 6, wherein the one or more guide walls further comprise a second rear guide wall disposed adjacent the rear portion of the housing's interior area, wherein the second rear guide wall is configured to engage the rear portion of the cart body during insertion of the rear portion of the cart body into the interior area of the housing.

8. The dispenser of claim 7, wherein the one or more guide walls further comprises a second lateral guide wall disposed adjacent a second lateral side of the housing's interior area;
wherein the first lateral guide wall is positioned adjacent a front portion of the cart body when the moveable cart is fully inserted to a loaded position within the housing's interior area;
wherein the second lateral guide wall is positioned adjacent a rear portion of the cart body when the moveable cart is fully inserted to the loaded position within the housing's interior area; and
wherein the first rear guide wall and second rear guide wall are positioned adjacent a first lateral side of the cart body when the moveable cart is fully inserted to the loaded position within the housing's interior area.

9. The dispenser of claim 1, wherein the one or more housing walls comprise a first side wall defining a first lateral side of the housing and a second side wall defining a second lateral side of the housing; and
wherein the one or more guide walls comprises a first lateral guide wall positioned adjacent to and inwardly from the first side wall and a second lateral guide wall positioned adjacent to and inwardly from the second side wall.

10. The dispenser of claim 9, wherein the one or more housing walls further comprise a rear wall defining a rear portion of the housing; and
wherein the one or more guide walls further comprise one or more rear guide walls positioned adjacent to and inwardly from the rear wall.

11. The dispenser of claim 10, wherein the first side wall comprises a first side panel, the second side wall comprises a second side panel, and the rear wall comprises a rear cross bar.

12. The dispenser of claim 1, wherein the one or more guide walls comprise separate guide wall members.

13. The dispenser of claim 1, wherein the cart guide apparatus further comprises a wheel support assembly configured for supporting the moveable cart when the cart is fully inserted to a loaded position within the housing's interior area, the wheel support assembly comprising:
a front wheel support for supporting one more front wheels of the moveable cart when the cart is fully inserted to the loaded position within the housing's interior area; and
a rear wheel support for supporting one or more rear wheels of the moveable cart when the cart is fully inserted to the loaded position within the housing's interior area.

14. The dispenser of claim 13, wherein the one or more guide walls extend upwardly from the wheel support assembly and are configured to engage the cart body when one or more of the moveable cart's wheels are positioned upon the wheel support assembly.

15. The dispenser of claim 1, wherein the one or more guide walls are configured to enable the moveable cart to be guided into the loaded position within the housing's interior area without restricting the movement of the moveable cart by direct engagement with the cart's plurality of wheels.

16. A method of inserting a moveable storage cart into a dispenser, the moveable storage cart comprising a cart body, one or more front wheels disposed adjacent a front portion of the cart body, and one or more rear wheels disposed adjacent a rear portion of the cart body, and the dispenser comprising a housing, including one or more housing walls defining an access opening and an interior area, and a cart guide apparatus comprising one or more guide walls positioned substantially within the housing, the method comprising the steps of:
moving the cart into a first position in which the cart body is oriented at an angle to the housing's access opening;
rolling the cart from the first position to a second position in which the front portion of the cart body is inserted within the interior area of the housing and engages one or more of said one or more guide walls; and
rotating the cart from the second position to a third position in which the cart is positioned within the interior area of the housing, the step of rotating the cart comprising rotating the cart about at least one of its one or more front wheels until the rear portion of the cart engages one or more of said one or more guide walls.

17. The method of claim 16, wherein the step of moving the cart into the first position comprises orienting the cart such that a longitudinal axis of the cart is at an angle between about 10 and about 80 degrees with respect to a plane defined by the housing's access opening.

18. The method of claim 16, wherein the steps of moving the cart into the first position, rolling the cart from the first position to the second position, and rotating the cart from the second position to the third position are executed without engaging the cart body with the one or more housing walls.

19. The method of claim 16, wherein the steps of moving the cart into the first position, rolling the cart from the first position to the second position, and rotating the cart from the second position to the third position are executed without engaging the cart's plurality of wheels with a portion of the dispenser such that the movement of the plurality of wheels is directly restricted.

20. The method of claim 16, wherein the one or more housing walls comprise a first side wall defining a first lateral side of the housing and a rear wall defining a rear portion of the housing, wherein the one or more guide walls comprise a first lateral guide wall positioned adjacent to and inwardly from the first side wall and one or more rear guide walls positioned adjacent to and inwardly from the rear wall;
wherein the step of rolling the cart from the first position to the second position comprises rolling the cart into the interior area of the housing through the access opening until the front portion of the cart body engages the first lateral guide wall and at least one of the one or more rear guide walls; and
wherein the step of rotating the cart from the second position to the third position comprises rotating the cart body about at least one of the one or more front wheels such that a rear portion of the cart body moves into the interior area of the housing through the access opening until the rear portion of the cart body engages at least one of the one or more rear guide walls.
